(19) United States
(12) Patent Application Publication
(10) Pub. No.: US 2026/0336905 A1
(43) Pub. Date: Oct. 29, 2026

(54) CARTRIDGES FOR ENHANCING PACKAGED BEVERAGES

(71) Applicant: Beverage Booster Inc., Boulder, CO (US)

(72) Inventors: Matthew Alex Cutter, Boulder, CO (US); Maxiliaan Gulden, Boulder, CO (US); Daniel Joseph Bodenstein, Boulder, CO (US); Stephen Kent Savage, Boulder, CO (US); Keir David Hart, Lafayette, CO (US)

(21) Appl. No.: 19/655,320

(22) Filed: Apr. 22, 2026

Related U.S. Application Data
(60) Provisional application No. 63/796,840, filed on Apr. 29, 2025.

(51) Int. Cl. B65D 81/32; A23L 2/58; B01F 23/2361; B01F 23/237; B65D 85/72; C12C 11/11; B01F 101/14; B01F 101/15

(52) U.S. Cl. CPC B65D 81/3216; A23L 2/58; B01F 23/23611; B01F 23/237621; B01F 23/23765; B65D 85/72; C12C 11/11; B01F 2101/14; B01F 2101/15

(57) ABSTRACT

The present disclosure provides a cartridge for enhancing a packaged beverage. In an aspect, the cartridge includes a body and cap that is securely affixed together. The body includes an inner chamber formed between the cap and a bottom wall. A first orifice extends from the inner chamber to an external environment through the bottom wall of the body and a second orifice extends from the inner chamber to the external environment through the cap. The first and second orifices are configured to allow gas to ingress when the cartridge reaches a pressure equilibrium with the packaged beverage. Upon opening of the container, the first and second orifices are positioned to create a vortex when gas egresses from the inner chamber to the environment external to the cartridge, in some cases causing the cartridge to spin, thereby agitating the packaged beverage.

### CROSS-REFERENCE TO RELATED APPLICATIONS

This application claims priority to Provisional U.S. Application No. 63/796,840, titled "SINGLE CHAMBER CARTRIDGE FOR ENHANCING PACKAGED BEVERAGES", filed Apr. 29, 2025, which is hereby incorporated by reference in its entirety.

### FIELD OF INVENTION

The present disclosure relates to beverage enhancement devices, and more particularly to a cartridge designed to rejuvenate carbonated or nitrogenated beverages using pressure-activated gas release through strategically positioned orifices.

### BACKGROUND

Packaged beverages, particularly carbonated and nitrogenated drinks, are widely popular for their refreshing taste and convenience. However, these beverages face challenges in maintaining their quality over time, which can negatively impact consumer satisfaction. The primary issue affecting carbonated and nitrogenated drinks is the gradual loss of dissolved gases, which are essential for their characteristic effervescence and mouthfeel.

Carbonation and nitrogenation play crucial roles in defining the sensory experience of many beverages. Carbon dioxide provides the familiar fizz and tingling sensation associated with sodas and sparkling waters, while nitrogen creates the creamy texture found in certain beers and coffee drinks. However, these gases tend to escape from the liquid over time, especially after the container is opened. This loss of dissolved gases can result in a flat or stale-tasting drink, diminishing the overall enjoyment for the consumer.

The degradation of carbonation and nitrogenation in packaged beverages is influenced by various factors. The permeability of packaging materials can allow gases to slowly escape, even when the container is sealed. Temperature fluctuations during storage and transportation can accelerate gas loss, as higher temperatures increase the solubility of gases in liquids. Additionally, the headspace in partially filled containers provides room for dissolved gases to come out of solution, further contributing to the loss of carbonation or nitrogenation.

The beverage industry has explored various approaches to address these challenges and maintain the desired level of carbonation or nitrogenation in packaged drinks. Despite these efforts, maintaining the optimal level of carbonation or nitrogenation throughout a beverage's shelf life remains a challenge. The gradual loss of these gases not only affects the drink's texture and mouthfeel but can also impact its flavor profile, as the presence of dissolved gases influences how flavor compounds are perceived by the consumer.

### SUMMARY

The present disclosure relates to a cartridge for use with a beverage container, and to a packaged beverage containing such a cartridge, configured to enhance the beverage upon opening.

In one aspect, a cartridge for enhancing a packaged beverage is provided. The cartridge includes a cylindrical body having a top end and a bottom end, with an exterior wall extending from the bottom end toward the top end to define an inner chamber. A bottom wall forms a bottom surface of the inner chamber and includes a first orifice defining a first channel extending between the inner chamber and an exterior environment. A cap is configured to be secured to the top end of the cylindrical body to enclose the inner chamber. The cap includes a first side and a second side, the second side being approximately perpendicular to the first side, and a second orifice defining a second channel extending between the inner chamber and the exterior environment.

The cap includes an attachment surface configured to form a seal between the cap and the cylindrical body. In certain embodiments, the attachment surface is formed by a protrusion extending from the cap and configured to engage an interior surface of the exterior wall of the cylindrical body. The protrusion may include multiple adjoining surfaces arranged at differing orientations relative to a longitudinal axis of the cylindrical body, thereby defining a stepped contact profile. The stepped contact profile is configured to progressively engage the cylindrical body as the cap is seated, producing radial compression and forming a sealing attachment interface.

In some embodiments, the cap is secured to the cylindrical body by one or more snap-fit features. Each snap-fit feature may include a tab arm extending from the cap and having a latching hook at a distal end, and a retention member disposed on the cylindrical body. The latching hook is configured to engage the retention member to secure the cap to the cylindrical body. In other embodiments, the cap and cylindrical body are integrally formed as a unitary structure, optionally including a living hinge having a hinge web defined by a localized reduced-thickness section.

The first orifice and the second orifice define restricted cross-sectional channels between the inner chamber and the exterior environment. The restricted geometry is configured to permit ingress of dissolved gas into the inner chamber until pressure equilibrium is achieved while restricting premature egress of gas. In certain embodiments, one or both of the channels taper from a first diameter at the inner chamber to a second diameter at the exterior environment, with the taper forming an angle relative to a longitudinal axis of the respective channel.

The first orifice and the second orifice may be positioned and oriented to direct gas egress from the inner chamber in opposing directions. In some configurations, the orifices are angularly offset about a longitudinal axis of the cylindrical body. Upon depressurization of the beverage container, gas discharged through the orifices produces opposing jets that generate shear forces and induce vortex flow within the packaged beverage. In certain embodiments, the opposing discharge may further generate torque on the cartridge, inducing rotational motion within the beverage.

In operation, when the cartridge is disposed within a container containing a packaged beverage, dissolved gas from the beverage enters the inner chamber through the first orifice and the second orifice until pressure equilibrium is established. Upon opening of the container and resulting depressurization, gas within the inner chamber is discharged through the orifices into the beverage. The restricted cross-sectional geometry and orientation of the orifices control the discharge profile and promote mixing, agitation, and redistribution of gas within the beverage.

In some embodiments, the cartridge includes one or more structural features configured to control positioning within the container. For example, the cartridge may include a plurality of wing tabs configured to contact an interior surface of the container to limit movement of the cartridge during storage and activation. In other embodiments, the cartridge may be configured to rotate within the beverage during discharge to further enhance mixing.

In another aspect, a packaged beverage is provided that includes a container containing a beverage and a cartridge disposed within the container. The cartridge is configured such that dissolved gas from the beverage ingresses into an inner chamber of the cartridge prior to opening, and is subsequently discharged through one or more orifices upon depressurization of the container. The discharged gas generates vortex flow within the beverage, enhancing mixing, carbonation or nitrogenation, and overall sensory characteristics.

In certain embodiments, the cap and cylindrical body are configured to maintain sealing engagement under elevated internal pressure within the inner chamber, including pressures of at least 55 psi. The sealing interface formed between the cap and the cylindrical body resists leakage and structural separation while permitting controlled release of gas through the orifices.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The foregoing general description of the illustrative embodiments and the following detailed description thereof are merely exemplary aspects of the teachings of this disclosure and are not restrictive.

### BRIEF DESCRIPTION OF FIGURES

The accompanying drawings, which are incorporated into and constitute a part of this specification, illustrate one or more certain aspects and, together with the description of the example, serve to explain the principles and implementations of the certain examples.

FIGS. 1-9 illustrate various perspectives of an example cartridge for enhancing a packaged beverage, according to various embodiments herein.

FIGS. 10-11 illustrate another example cartridge for enhancing a packaged beverage, according to various embodiments herein.

FIG. 12 illustrates an example cartridge including wing tabs, according to an embodiment herein.

FIGS. 13A-B illustrates illustrated example perspectives of a cartridge in operation within a beverage container, according to an embodiment herein.

Corresponding components in the various embodiments may be identified by similar reference numerals. Features described with respect to one embodiment may be used in combination with features of other embodiments.

### DETAILED DESCRIPTION

Packaged beverages, particularly carbonated and nitrogenated drinks, have become ubiquitous in modern society, readily available in countless markets, convenience stores, vending machines, and households worldwide. These beverages, ranging from sodas to sparkling waters and specialty beers, offer consumers a convenient and refreshing option for quenching thirst or indulging in a flavorful treat. Their popularity stems from a combination of factors, including their portability, long shelf life, and diverse flavor options, catering to a wide range of tastes and preferences. Whether enjoyed on their own or paired with meals, packaged carbonated and nitrogenated beverages have become ingrained in daily life, serving as go-to options for hydration, relaxation, or social gatherings. Their widespread availability and enduring appeal highlight their status as staples of modern beverage consumption.

One drawback of packaged carbonated and nitrogenated beverages is the inevitable loss of dissolved gases over time, influenced by various factors including packaging permeability and temperature fluctuations. Despite efforts to maintain freshness, these beverages can undergo undesirable changes in taste, texture, and quality due to their susceptibility to gas loss. Gas escape poses a significant challenge, occurring through various channels. In bottled beverages, imperfect seals between the cap and bottle can allow gases to slowly seep out, while canned drinks may experience loss through micro-defects in the can's seal.

Additionally, temperature fluctuations during storage play a crucial role in accelerating gas loss. Fluctuations in temperature can cause expansion and contraction of the packaging material and the beverage itself, leading to changes in internal pressure and subsequent loss of carbonation or nitrogenation. These variations can occur during transportation, storage, or even in-store display, exacerbating the degradation process. Combined with packaging permeability, temperature fluctuations contribute to the gradual loss of dissolved gases within the beverage, resulting in changes such as a loss of effervescence, diminished mouthfeel, or a decline in overall palatability over time.

The negative effects of gas loss extend beyond mere changes in taste and texture, impacting both consumers and producers alike. One consequence is the limited shelf life of packaged carbonated and nitrogenated beverages, which directly affects their marketability and profitability. As the beverage loses its characteristic fizz or creamy texture, it becomes less appealing to consumers, leading to decreased sales and potential waste if unsold inventory reaches its expiration date. This not only results in financial losses for producers but also contributes to environmental concerns due to increased packaging waste. Moreover, loss of carbonation or nitrogenation can tarnish a brand's reputation, eroding consumer trust and loyalty over time. Overall, the negative effects of gas loss extend beyond the sensory experience, impacting the economic viability, environmental sustainability, and brand image of packaged beverage producers.

To address gas loss and its negative consequences for packaged carbonated and nitrogenated beverages, example systems and techniques are provided herein. In particular, an example cartridge is provided that is configured to charge with dissolved gas from a packaged beverage and to release that gas back into the packaged beverage upon opening. The cartridge includes a body defining an inner chamber and a cap secured to the body. The cap and the body are configured to remain secured together under internal pressure conditions associated with packaged beverages, thereby maintaining the integrity of the inner chamber during storage, transport, and handling.

The cartridge further includes one or more orifices extending between the inner chamber and the packaged beverage. In some embodiments, the one or more orifices include a first orifice and a second orifice. The one or more orifices are configured to permit dissolved gas from the packaged beverage to ingress into the inner chamber until pressure equilibrium is established between the inner chamber and the packaged beverage. In this manner, the inner chamber becomes charged with dissolved gas during storage without requiring a separate filling operation after insertion of the cartridge into the packaged beverage.

In some embodiments, to seal the cap onto the body of the cartridge, the cap includes a protrusion configured to engage a body lip of the body to form an attachment surface. In such cases, the protrusion includes adjoining surfaces arranged at differing orientations relative to a longitudinal axis of the body, the adjoining surfaces defining a stepped contact profile. The stepped contact profile is configured to progressively engage the body lip as the cap is secured to the body, thereby producing radial compression across multiple contact regions. This compound, multi-angle geometry enhances sealing integrity and improves resistance to internal pressure within the inner chamber, which is particularly important for packaged carbonated and nitrogenated beverages that are stored under elevated pressure and subject to pressure fluctuations. The stepped contact profile reduces the likelihood of gas leakage and supports consistent retention of gas within the inner chamber during storage and distribution.

Upon depressurization of the packaged beverage when opened by a consumer, the pressure differential between the inner chamber and the packaged beverage causes gas within the inner chamber to be discharged through the one or more orifices into the packaged beverage. In embodiments including the first orifice and the second orifice, these orifices may be angularly offset about the longitudinal axis of the body to cause the gas to egress in opposing directions. Because the first orifice and the second orifice are circumferentially separated, gas is discharged along different radial vectors within the packaged beverage.

The opposing discharge generates localized jets that introduce shear forces into the liquid and induce vortex flow within the packaged beverage. The vortex flow promotes mixing and agitation of the packaged beverage upon opening, increasing interaction between the released gas and the liquid phase. This enhanced mixing improves dissolution of the discharged gas, supports uniform gas distribution, and reduces localized overconcentration of bubbles. The resulting flow dynamics can reinforce carbonation or nitrogenation, improve foam formation, and enhance mouthfeel and texture. In addition, the induced agitation can re-suspend settled components and promote a more uniform sensory profile without requiring manual shaking by the consumer.

As noted, the cartridge may release gaseous components that are selected to rejuvenate or enhance the carbonation or nitrogenation of the packaged beverage. For example, in a carbonated soft drink, gas discharged from the inner chamber may restore effervescence that has diminished during storage. In nitrogenated beverages such as beer or coffee drinks, the released gas may enhance creaminess, foam stability, and mouthfeel. In other embodiments, the released gas may create an experiential effect, such as intensified bubbling or visual agitation within the packaged beverage upon opening.

In some embodiments, in addition to rejuvenating or enhancing carbonation or nitrogenation, the cartridge may enable a reduction in the amount of gas required during initial beverage production. By providing a controlled release of gas at the point of consumption, the beverage may be initially filled with a lower gas content while still achieving a desired carbonation or nitrogenation level upon opening. This can reduce manufacturing costs, improve process efficiency, and mitigate losses associated with gas diffusion during storage. The enhanced sealing provided by the protrusion and the stepped contact profile further supports this functionality by maintaining gas within the inner chamber until release is desired.

As will be described in greater detail below, the cartridge provides numerous benefits to both beverage producers and consumers. By addressing gas loss and enabling controlled gas release and mixing upon opening, the cartridge can extend the effective shelf life of packaged carbonated and nitrogenated beverages and improve consistency of product performance. The ability to maintain sealing integrity under pressure, combined with vortex-generating discharge through the one or more orifices, supports reliable and repeatable enhancement of beverage characteristics. These features contribute to improved consumer satisfaction, reduced product variability, and enhanced economic and environmental efficiency for beverage production and distribution.

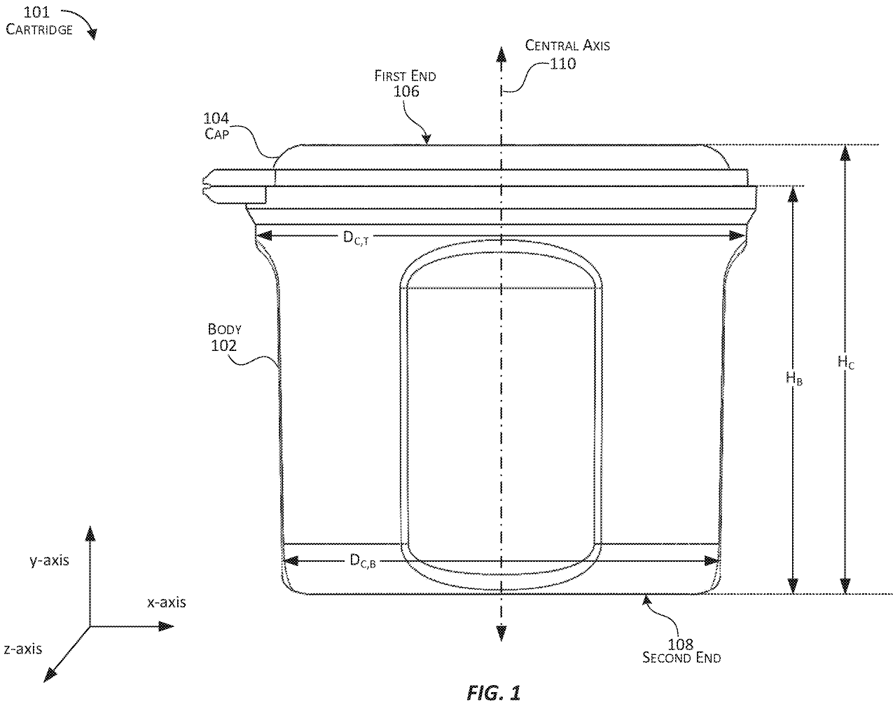

Referring now to the FIGS. 1-9, various perspectives of an example cartridge 101 including a body 102 and a cap 104 are illustrated, according to various embodiments herein. The cartridge 101 may be configured to be inserted into a packaged beverage. Packaged beverages, as used herein, are meant to encompass any beverage that is packaged in a container for convenient transportation and consumption. The containers of packaged beverages may be made from a variety of materials, including aluminum, glass, plastic, and cartons. The packaged beverages themselves may be a wide range of drinks, from water, juice, and milk to teas, coffees, and alcoholic beverages such as beer or ready-to-drink (RTD) cocktails. While the following discussion focuses on carbonated beverages, such as beer and sparkling water, it should be appreciated that the discussion is equally applicable to other types of beverages.

As shown by perspective 100 of FIG. 1, the cartridge 101 has an approximately cylindrical shape defined about a central axis 110 (also referred to herein as a longitudinal axis) extending along a y-axis between a first end 106 to a second end 108 of the cartridge 101. As shown, the cartridge 101 is approximately symmetrical about the central axis 110. The cartridge 101 has a cartridge height, H_{C}, a cartridge top diameter, D_{C,T}, and a cartridge bottom diameter, D_{C,B}. The cartridge height, H_{C}, of the cartridge 101 is defined parallel to the central axis 110 while the cartridge top diameter, D_{C,T} and the cartridge bottom diameter, D_{C,B} are defined as orthogonal to the central axis 110. In an embodiment, the cartridge height, H_{C}, may be defined along the y-axis and the cartridge top diameter, D_{C,T} and the cartridge bottom diameter, D_{C,B} may be defined along the x-axis, as shown.

The size and shape of the cartridge 101 may vary depending on application, such as the packaged beverage into which the cartridge 101 is inserted into. For example, if the cartridge 101 is configured to be inserted via a mouthpiece of a bottle, such as a beer bottle, then the cartridge 101 may have larger cartridge height, H_{C}, and a smaller cartridge top diameter, D_{C,T} and smaller cartridge bottom diameter, D_{C,B}, to fit through the slender mouthpiece of the bottle. In contrast, if the cartridge 101 is configured to be inserted into a can during a canning process (e.g., prior to the lid of the can being affixed), then the cartridge 101 may have a lower cartridge height, H_{C}, and the cartridge top diameter, D_{C,T} and the cartridge bottom diameter, D_{C,B}, may be larger. Moreover, the size and shape of the cartridge 101 may depend on the amount of remediating component being discharged into the packaged beverage, as will be described in greater detail below. While the illustrated example cartridge 101 has a cylindrical body, other body shapes are contemplated herein, including spherical, elliptical, conical, rectangular, or other polygonal shapes. The shape of the body 102 may be selected based on factors such as the geometry of the beverage container, manufacturing considerations, desired gas release characteristics, or aesthetic preferences.

It should also be appreciated that while the following discussion focuses on the cartridge 101 as configured to be inserted into a personal-use sized packaged beverage (e.g., single 12-20 ounce can or bottle), the cartridge 101 may be configured for insertion into larger packaged beverages, such as a keg-style containers or larger carbonated storage containers. In such cases, while the cartridge 101 may be larger, however, the function and below description of the cartridge 101 may be equally applicable. Additionally, the dimensions of the cartridge 101 may vary depending on the application (e.g., insertion into a can vs. a glass bottle), even within personal-use sized packaged beverages.

In example embodiments, the cartridge height, H_{C}, may be in a range from 10 to 60 millimeters (mm), including ranges from 15mm to 50mm, 20mm to 45mm, 20mm to 40mm, 25mm to 35mm, 20mm to 30mm, 20mm to 25mm, and 15mm to 20mm. Similarly, in example embodiments, each of the cartridge top diameter, D_{C,T} and the cartridge bottom diameter, D_{C,B} may be in a range from 10mm to 60mm, including sub-ranges from 20mm to 50mm, from 20mm to 40mm, and from 20mm to 30mm. As shown, the cartridge top diameter, D_{C,T} and the cartridge bottom diameter, D_{C,B} are different diameters, specifically the cartridge top diameter, D_{C,T} being larger than the cartridge bottom diameter, D_{C,B}. In some embodiments, however, the cartridge top diameter, D_{C,T} and the cartridge bottom diameter, D_{C,B}, may be the same.

In the illustrated embodiment, the cartridge top diameter, D_{C,T} corresponds to a diameter of the cartridge 101 at a location where the body 102 interfaces with the cap 104. In particular, the cartridge top diameter, D_{C,T} is defined by the outer extent of the body 102 and the cap 104 at the attachment interface, including the region where the attachment surface is formed between the cap 104 and the exterior wall of the body 102. As such, the cartridge top diameter, D_{C,T} reflects the maximum radial dimension of the cartridge 101 at the sealing interface between the cap 104 and the body 102.

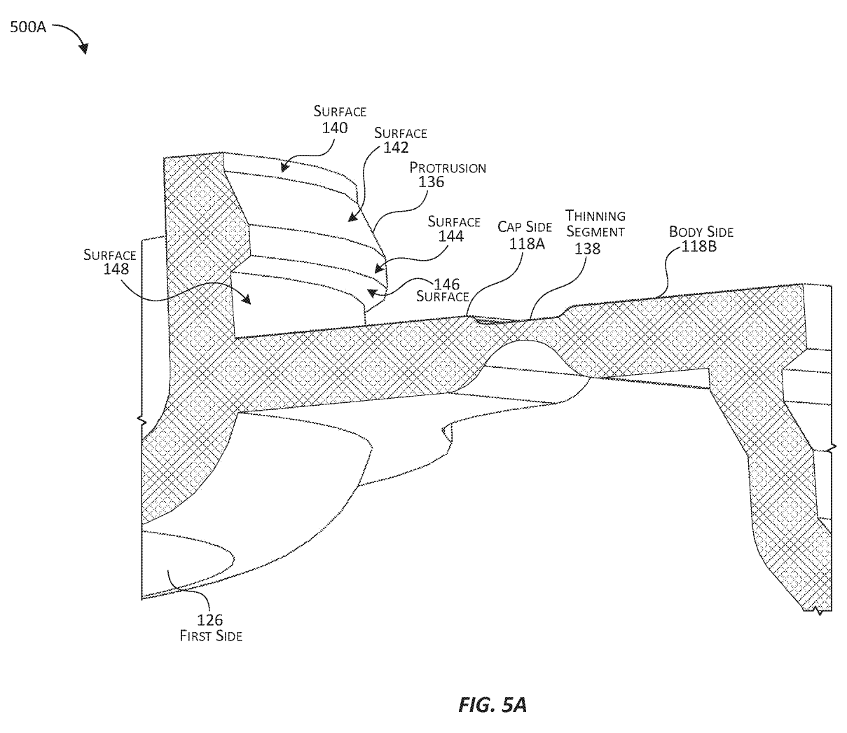

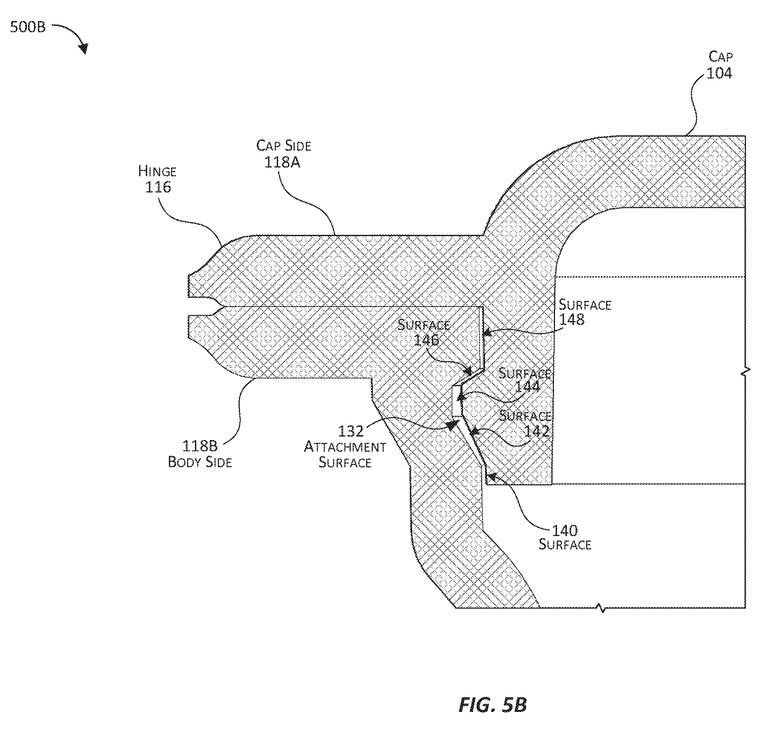

The increased cartridge top diameter, D_{C,T} may provide several structural and functional benefits. The larger diameter increases the available surface area at the interface between the cap 104 and the body 102, which supports formation of a more robust attachment surface and improves sealing performance. In embodiments including a protrusion extending from the cap 104, such as those described in greater detail below with respect to FIGS. 4-5B, the larger cartridge top diameter, D_{C,T} provides additional radial space for the protrusion and adjoining surfaces to engage the body 102, enabling formation of a stepped contact profile that progressively engages the exterior wall. This increased engagement area improves distribution of contact forces, enhances radial compression at the interface, and reduces localized stress concentrations that could otherwise lead to leakage.

The larger cartridge top diameter, D_{C,T} may also improve resistance to internal pressure within the inner chamber by increasing the effective sealing circumference at the cap-body interface. This is particularly beneficial for packaged carbonated and nitrogenated beverages, where internal pressure conditions can be elevated and subject to fluctuation. By increasing the sealing interface area and distributing loads across the stepped contact profile, the cartridge 101 maintains sealing integrity during storage and handling.

In contrast, the smaller cartridge bottom diameter, D_{C,B} facilitates insertion of the cartridge 101 into a beverage container and reduces obstruction to fluid flow within the packaged beverage. The difference between the cartridge top diameter, D_{C,T} and the cartridge bottom diameter, D_{C,B} thereby provides a combination of enhanced sealing performance at the cap-body interface and improved compatibility with container geometry and fluid flow within the beverage.

In an illustrative embodiment, the cartridge height, H_{C}, is 23mm, the cartridge top diameter, D_{C,T} is 27mm, and the cartridge bottom diameter, D_{C,B}, is 27mm. In another illustrative example, the cartridge height, H_{C}, may be approximately 25mm while the cartridge top diameter, D_{C,T} is 28mm, and the cartridge bottom diameter, D_{C,B}, is 27mm.

As shown, the body 102 includes a top end 112 and a bottom end 114, and is cylindrical in shape having a body height, H_{B}. The body height, H_{B}, is defined parallel to the central axis 110. As noted above, depending on the configuration and application of the cartridge 101, the body height, H_{B}, may range from 10 to 60mm, including ranges from 15mm to 50mm, 18mm to 45mm, 20mm to 40mm, 20mm to 35mm, 20mm to 30mm, 22mm to 26mm, and 23mm to 25mm. In an example embodiment, the body height is 24mm, while the cartridge height is 27mm.

In some embodiments, the cap 104 and the body 102 of the cartridge 101 are monoformed, meaning that the cartridge 101 is created as a single integrated piece (e.g., unibody) having a unitary structure, typically through a molding or manufacturing process. In such embodiments, the cap 104 and the body 102 are integrally formed from a common material and may include an integrally formed living hinge or other connecting structure. This unitary construction eliminates separate assembly steps and improves alignment and sealing consistency between the cap 104 and the body 102, resulting in a more robust and reliable cartridge 101.

During a monoforming process, molten material is injected or molded into a single cavity mold, shaping all components simultaneously (e.g., the cap 104 and the body 102). The monoforming process ensures precise alignment and fit between the cap 104 and the body 102, resulting in a seamless and robust cartridge structure. By forming the cap 104 and the body 102 together, potential issues such as misalignment, leakage, or weak joints, often encountered in multi-piece assemblies, are minimized or eliminated. Additionally, monoforming streamlines production processes, reduces assembly time and costs, and enhances the overall reliability and performance of the cartridge 101. In some embodiments, the components of the cartridge 101 discussed below may also be formed as part of the monoforming process, meaning that the cartridge 101 is a single integrated piece. By leveraging monoforming, breakage concerns are significantly reduced with a single-piece construction, mitigating the risk of any detached components being inadvertently ingested by the consumer.

The cartridge 101 may be formed out of or include one or more food-grade materials, such as food-grade polymers, elastomers, aluminum, and the like. Examples of food-grade polymers may include high-density polyethylene (HDPE), low-density polyethylene (LDPE plastic), polyethylene terephthalate (PET/PETE), polypropylene (PP), polycarbonate (PC), acrylic (PMMA), polyetheretherketone (PEEK), acrylonitrile butadiene styrene (ABS), nylon (PA), and the like. Examples of food-grade elastomers may include neoprene, ethylene propylene diene monomer (EPDM), nitrile, silicon, and the like. In some embodiments, the material used to form the cartridge 101 may be selected based on the remediating component being housed by cartridge 101 to prevent absorption of the remediating component into the material (e.g., oil absorbed into PP). Additionally, manufacturing and assembly considerations may impact selection of the material to form the cartridge 101 or its components. For example, during the assembly process, the cartridge 101 or its interior components (e.g., inner chamber) may be subject to ultraviolet (UV) radiation. As such, a material that is food-grade but also UV stable may be selected to ensure durability and safety.

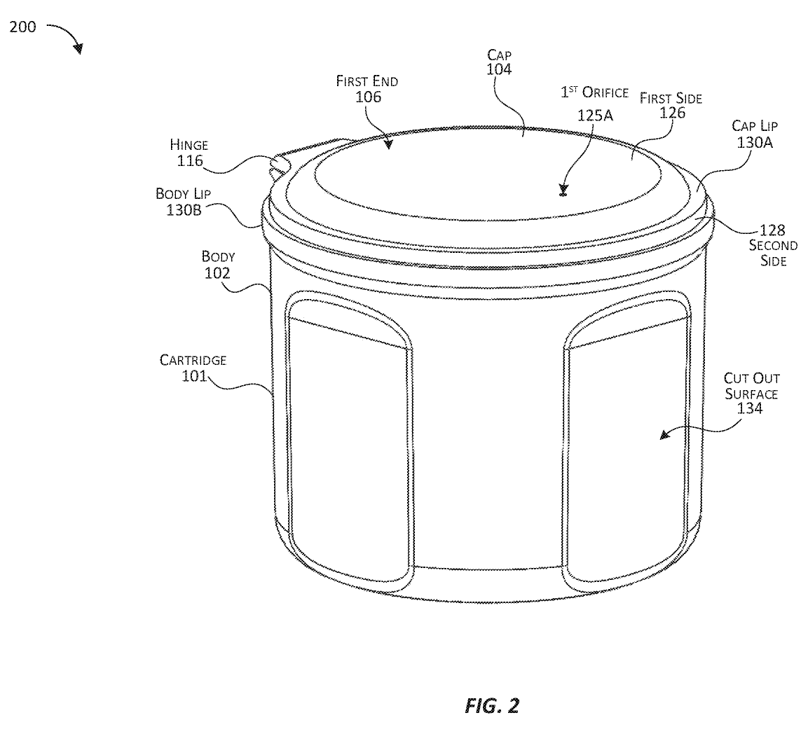

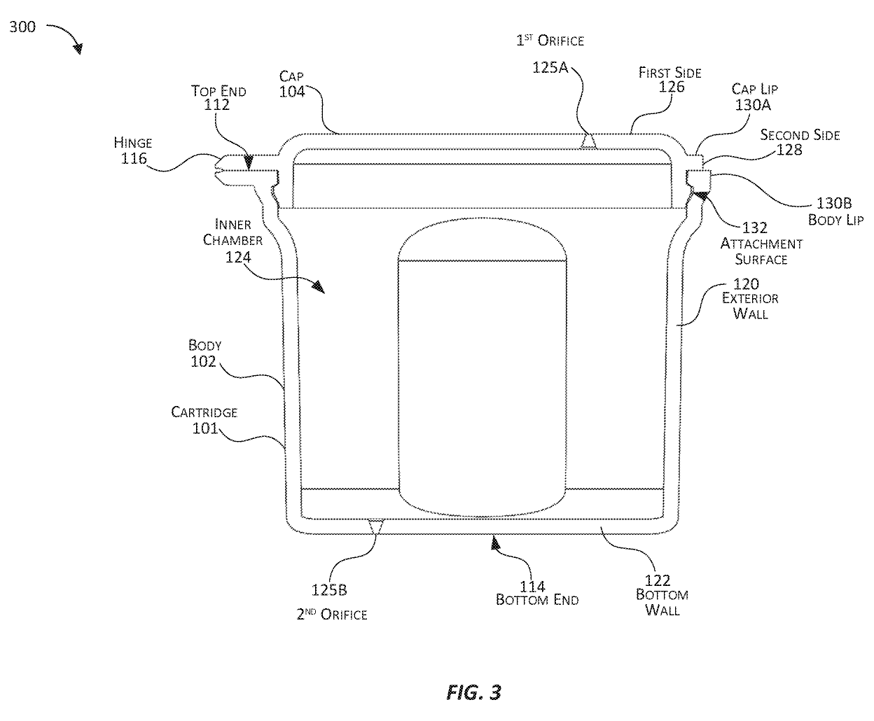

As shown in FIG. 2, in some embodiments, the body 102 includes one or more cutout surfaces 134 formed along the exterior wall 120. The cutout surfaces 134 define recessed regions extending inward from the exterior wall 120 and interrupting the otherwise continuous outer profile of the body 102. The cutout surfaces 134 facilitate alignment and orientation of the cartridge 101 during manufacturing and assembly, including positioning of the cap 104 relative to the body 102 prior to securing the cap 104 to the body 102. In some embodiments, multiple cutout surfaces 134 are circumferentially spaced about the exterior wall 120 to provide repeatable alignment features. The cutout surfaces 134 also reduce material usage and overall mass of the cartridge 101 and decrease volume displacement of the cartridge 101 within the packaged beverage. The size, shape, and number of the cutout surfaces 134 are selected based on manufacturing requirements, assembly tolerances, and desired performance characteristics of the cartridge 101.

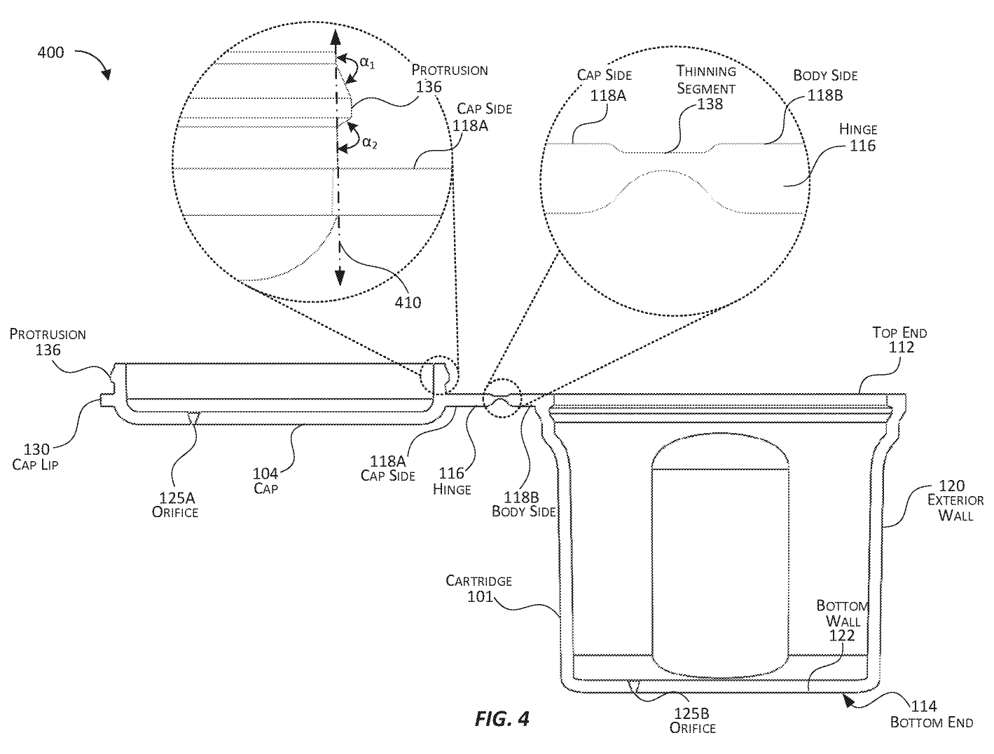

As shown in FIGS. 3-4, the cap 104 is attached to the body 102 by a hinge 116. The hinge 116 extends between a cap side 118A coupled to the cap 104 and a body side 118B coupled to the body 102. The hinge 116 maintains a physical connection between the cap 104 and the body 102 while allowing relative movement between the cap 104 and the body 102 during opening and closing of the cartridge 101. In the illustrated embodiment, the hinge 116 is integrally formed with the cap 104 and the body 102 as part of a unitary structure.

In some embodiments, the hinge 116 is a living hinge. The living hinge includes a hinge web defined by a localized reduced-thickness section that allows repeated flexing without fracture. The reduced thickness of the hinge web provides flexibility while maintaining structural continuity between the cap 104 and the body 102. The living hinge enables the cap 104 to pivot relative to the body 102 while remaining permanently attached.

As shown in FIG. 4, the hinge 116 includes a thinning segment 138 disposed between the cap side 118A and the body side 118B. The thinning segment 138 defines a region of reduced thickness relative to adjacent portions of the hinge 116 and localizes bending to the thinning segment 138 during movement of the cap 104 relative to the body 102. By concentrating flexural deformation within the thinning segment 138, the hinge 116 achieves controlled and repeatable bending behavior while reducing stress concentrations in surrounding regions of the cap 104 and the body 102.

The thinning segment 138 improves durability of the hinge 116 by reducing the likelihood of crack initiation and propagation during repeated opening and closing cycles. The reduced thickness also lowers the force required to pivot the cap 104, enabling smooth operation while maintaining sufficient structural integrity to keep the cap 104 attached to the body 102. In addition, the thinning segment 138 promotes predictable hinge motion by defining a consistent bend axis, which improves alignment of the cap 104 with the body 102 during closure and supports reliable sealing engagement between the cap 104 and the body 102.

In other embodiments, alternative hinge structures are used. For example, the hinge 116 is implemented as a mechanical hinge including one or more pivot joints, pins, or interlocking elements. In further embodiments, the cap 104 is connected to the body 102 by a flexible connector such as a strap, tether, or leash formed from polymer, wire, or other flexible material. These alternative connection structures maintain attachment between the cap 104 and the body 102 while permitting sufficient movement to allow opening and closing of the cartridge 101.

The hinge 116 has a length extending between the cap side 118A and the body side 118B. The length of the hinge 116 is selected to allow the cap 104 to move away from the body 102 to an open position during assembly of the cartridge 101. In particular, the hinge 116 allows the cap 104 to be positioned such that access to an inner chamber 124 is unobstructed when the cap 104 is in the open position. This configuration may facilitate insertion of one or more remediating components into the inner chamber 124 prior to securing the cap 104 to the body 102, as will be described in greater detail below. The hinge 116 thereby enables efficient assembly of the cartridge 101 while maintaining attachment between the cap 104 and the body 102.

The cap 104 is configured to be secured to the body 102 at the top end 112 to form the cartridge 101. In the illustrated embodiment, prior to insertion of the cartridge 101 into a packaged beverage, the cap 104 is seated onto the body 102 such that the cap 104 engages the body 102 to form a seal. The cap 104 remains secured to the body 102 during operation of the cartridge 101, including when the packaged beverage is opened and pressure conditions within the cartridge 101 change. The securement between the cap 104 and the body 102 is configured to maintain sealing engagement under internal pressure within the inner chamber, including pressure generated by expansion of gas within the cartridge 101. Specific structural features that form the seal between the cap 104 and the body 102 are described in greater detail below.

When the cap 104 is secured to the body 102, the inner chamber 124 is formed within the cartridge 101. The inner chamber 124 is defined by the interior space bounded by the exterior wall 120 and the bottom wall 122 of the body 102 and the cap 104. The inner chamber 124 extends from the bottom wall 122 toward the cap 104 and is enclosed when the cap 104 is secured to the body 102. The inner chamber 124 defines a contained volume within the cartridge 101 that is isolated from the surrounding environment except through one or more orifices 125A–B, as described in greater detail below.

The inner chamber 124 occupies a substantial portion of an internal volume of the body 102, with remaining material of the exterior wall 120 and the bottom wall 122 providing structural support and accommodating features such as the orifices 125A–B and associated sealing structures. The size and geometry of the inner chamber 124 are selected to balance structural integrity of the cartridge 101 with functional capacity for containing gas or remediating components. In addition, the geometry of the inner chamber 124 is configured to promote efficient filling during manufacturing and to facilitate controlled release of contents during operation of the cartridge 101.

In some embodiments, the inner chamber 124 defines a single continuous internal volume within the cartridge 101, such that the cartridge 101 is configured as a single-chamber cartridge. In this configuration, the inner chamber 124 is not subdivided by internal partitions and instead provides a unified space for receiving and releasing gas and/or remediating components.

The single-chamber configuration may provide several technical advantages. By maintaining a single continuous internal volume, pressure within the inner chamber 124 equalizes more uniformly with the surrounding packaged beverage, enabling predictable gas ingress through the orifices 125A–B and controlled release upon opening of the packaged beverage. The absence of internal partitions reduces internal flow resistance and promotes efficient discharge of gas and remediating components through the orifices 125A–B. In addition, the simplified internal geometry facilitates manufacturing and filling processes, improves reliability of sealing between the cap 104 and the body 102, and reduces the likelihood of incomplete discharge or retention of material within the inner chamber 124 during operation.

In other embodiments, the inner chamber 124 may include one or more internal partitions that define multiple chambers within the cartridge 101. Such configurations may be used to isolate different remediating components prior to release, as noted below. However, the single-chamber configuration described above may be preferred in applications where uniform pressure equalization and consistent discharge characteristics are desired.

In example embodiments, a volume of the inner chamber 124 is in a range from 5 milliliter (mL) to 20mL, including ranges from 8mL to 18mL, 10mL to 16mL, 11mL to 15mL, 12mL to 14mL, and 13mL to 14mL. In an illustrative example, the volume of the inner chamber 124 is 13.2mL. The volume of the inner chamber 124 is selected based on the desired quantity of gas or remediating components to be contained within the cartridge 101 and subsequently released into the packaged beverage.

The inner chamber 124 is configured to contain one or more remediating components. In some embodiments, the remediating component is the dissolved gas that ingresses into the inner chamber 124 from the packaged beverage through the orifices 125A–B, as described herein. In other embodiments, one or more additional remediating components are disposed within the inner chamber 124 prior to securing the cap 104 to the body 102. The additional remediating components are retained within the inner chamber 124 during storage and are released through the orifices 125A–B upon depressurization of the packaged beverage.

The remediating components may include gaseous, liquid, solid, or multi-phase materials configured to modify one or more properties of the packaged beverage. In some embodiments, the remediating components include liquid additives such as flavor concentrates, flavor oils, or extracts configured to enhance or restore a flavor profile at the time of consumption. In other embodiments, the remediating components include solid materials such as powders, granules, or effervescent agents configured to dissolve, react, or disperse within the packaged beverage upon release. In some configurations, multiple remediating components are disposed within the inner chamber 124, and the inner chamber 124 may be configured to include multiple compartments to maintain separation of different components prior to release. The volume and geometry of the inner chamber 124 are selected based on the type and quantity of remediating components and the desired release characteristics.

The inner chamber 124 includes internal features configured to enhance functionality of the cartridge 101. In some embodiments, the inner chamber 124 may include internal baffles, channels, or contours formed along an interior surface of the exterior wall 120 or the bottom wall 122 to direct flow of dissolved gas (or remediating components) toward the first orifice 125A and the second orifice 125B during discharge. In addition, interior surfaces of the inner chamber 124 are configured to reduce adhesion of contained components. For example, the interior surfaces defined by the exterior wall 120 and the bottom wall 122 include a coating or surface treatment that promotes release of gas or remediating components. Suitable coatings include food-grade, low-adhesion materials such as polytetrafluoroethylene (PTFE), silicone-based coatings, or food-safe lacquers. These coatings are particularly beneficial when the inner chamber 124 contains viscous or surface-adhering components, as they improve release efficiency without requiring increased volume of the inner chamber 124.

As illustrated in FIGS. 2 and 3, the cap 104 includes a first side 126 and a second side 128. The first side 126 is oriented approximately orthogonal to the second side 128, and the second side 128 extends generally parallel to the central axis 110 of the cartridge 101. The first side 126 defines a top-facing portion of the cap 104, while the second side 128 defines a sidewall portion that interfaces, in part, with the body 102.

The first side 126 and the second side 128 each include an interior surface and an exterior surface. The interior surface of the first side 126 faces toward the inner chamber 124, while the exterior surface of the first side 126 faces away from the inner chamber 124 toward the external environment. Similarly, the second side 128 includes an interior surface facing toward the body 102 and the inner chamber 124, and an exterior surface facing away from the body 102. The interior and exterior surfaces of the first side 126 and the second side 128 define boundary surfaces through which fluid communication may occur and along which sealing interactions with the body 102 are established.

As noted above, the inner chamber 124 is configured to receive dissolved gas from a packaged beverage when the cartridge 101 is disposed within the packaged beverage. To receive dissolved gas from the packaged beverage, the cartridge 101 includes a first orifice 125A extending through the first side 126 of the cap 104 and a second orifice 125B extending through the bottom wall 122 of the body 102. The first orifice 125A defines a channel 160 extending between the interior surface and the exterior surface of the first side 126. Similarly, the second orifice 125B defines a channel 160 extending between the inner chamber 124 and an external environment defined by the packaged beverage. Each of the first orifice 125A and the second orifice 125B defines a respective channel 160 that extends between the inner chamber 124 and the external environment. In the illustrated embodiment, the first orifice 125A and the second orifice 125B are pinhole orifices such to define restricted cross-sectional channels 160, respectively.

The location of the first orifice 125A and the second orifice 125B may vary depending on the configuration of the cartridge 101. In the illustrated embodiment, the first orifice 125A is positioned through the first side 126 of the cap 104 and the second orifice 125B is positioned through the bottom wall 122 at the bottom end 114 of the body 102, such that the first orifice 125A and the second orifice 125B are located at opposite ends of the cartridge 101. In other embodiments, the first orifice 125A and the second orifice 125B are positioned along the exterior wall 120. For example, the first orifice 125A is positioned through the exterior wall 120 at a location proximate the cap 104, and the second orifice 125B is positioned through the exterior wall 120 at a location proximate the bottom end 114 of the body 102 on an opposing side of the exterior wall 120. This arrangement positions the first orifice 125A and the second orifice 125B on opposing sides of the cartridge 101 and can be used to achieve desired flow characteristics during gas ingress and discharge.

When the cartridge 101 is inserted into the packaged beverage, dissolved gas within the packaged beverage enters the inner chamber 124 through the first orifice 125A and the second orifice 125B. Packaged beverages such as carbonated beverages and nitrogenated beverages are sealed under pressure, resulting in dissolved gas within the liquid. Upon insertion of the cartridge 101, a pressure differential exists between the packaged beverage and the inner chamber 124. This pressure differential drives ingress of dissolved gas through the first orifice 125A and the second orifice 125B into the inner chamber 124.

As dissolved gas enters the inner chamber 124, the pressure within the inner chamber 124 increases until the pressure within the inner chamber 124 reaches equilibrium with the pressure of the packaged beverage. The restricted cross-sectional geometry of the first orifice 125A and the second orifice 125B permits ingress of gas while limiting ingress of liquid, thereby maintaining the inner chamber 124 substantially free of liquid during charging.

Each of the first orifice 125A and the second orifice 125B defines a channel 160 extending between the inner chamber 124 and the packaged beverage. The channel 160 is formed through the bottom wall 122 of the body 102 and/or through the cap 104 depending on the location of the respective orifice. In some embodiments, the channel 160 has a substantially cylindrical shape with a consistent diameter along its length, which provides predictable flow behavior and simplifies manufacturing.

The diameter of each of the first orifice 125A and the second orifice 125B is selected to control gas exchange between the inner chamber 124 and the packaged beverage. In example embodiments, the diameter of each orifice 125A-B may be in a range from 0.1mm to 1.5mm, including ranges of 0.2mm to 1mm, 0.3mm to 0.9mm, 0.4mm to 0.8mm, and 0.5mm to 0.7mm. In one example configuration, the diameter is approximately 0.3mm. These dimensions are selected to permit ingress of dissolved gas while restricting liquid entry and to control the rate of gas discharge upon opening of the packaged beverage.

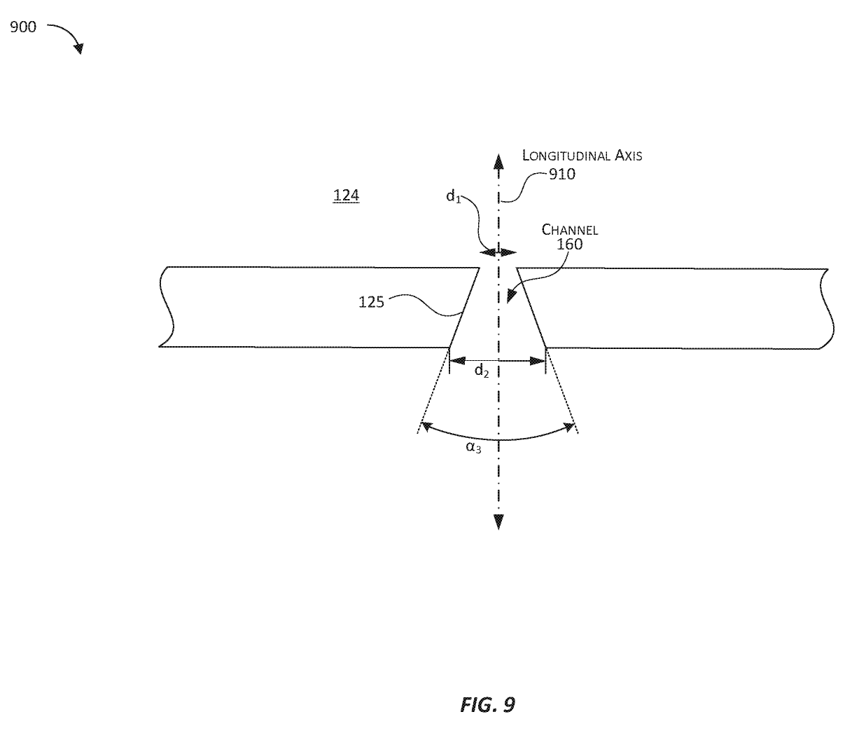

As shown in FIG. 9, in the illustrated embodiment the channel 160 has a tapered or conical profile extending along a channel longitudinal axis 910. The channel 160 includes a first diameter, d₁, adjacent the inner chamber 124 and a second diameter, d₂, adjacent the packaged beverage. In the illustrated embodiment, the first diameter, d₁ is less than the second diameter, d₂ such that the channel 160 expands in a direction away from the inner chamber 124 along the channel longitudinal axis 910. The taper of the channel 160 defines an angle, α₃, relative to the channel longitudinal axis 910. The diverging geometry of the channel 160 defines a restricted minimum diameter at d₁ that limits ingress of liquid into the inner chamber 124 while still permitting dissolved gas to enter. The expanding profile downstream of d₁ reduces flow resistance and promotes consistent gas ingress from the packaged beverage into the inner chamber 124 during pressurization.

The tapered geometry of the channel 160 also influences discharge behavior. Gas egressing from the inner chamber 124 expands as it flows from the smaller first diameter, d₁ toward the larger second diameter, d₂, producing a distributed, radially expanding flow into the packaged beverage. This expanding discharge increases the interaction area between the released gas and the surrounding liquid, thereby enhancing mixing, agitation, and vortex formation upon opening of the packaged beverage. In some embodiments, the channel 160 is defined by a conical surface forming an angle relative to a longitudinal axis of the channel 160, where the angle, α₃, is in a range from 5 to 50 degrees, from 10 to 40 degrees, or from 30 to 40 degrees. The angle, α₃, is selected to balance resistance to liquid ingress, efficiency of gas ingress, and the desired discharge profile during depressurization.

In other embodiments, the channel 160 has a converging profile such that the first diameter, d₁ is greater than the second diameter, d₂ and the channel 160 tapers in a direction toward the packaged beverage (not shown). This converging configuration increases flow restriction at the outlet and can accelerate gas during discharge to produce a more focused, higher-velocity jet. Such a configuration may be selected to increase discharge intensity and localized agitation within the packaged beverage. The orientation and geometry of the channel 160 are selected based on desired gas ingress characteristics, discharge intensity, mixing behavior, and manufacturing considerations.

The size, number, and placement of the first orifice 125A and the second orifice 125B are selected to control gas ingress and subsequent gas discharge. In some embodiments, the cartridge 101 includes more than two orifices, including additional orifices formed in the body 102 and/or the cap 104. As the number of orifices increases, a cross-sectional area of each individual orifice decreases such that a total orifice surface area remains within a desired range. Conversely, when fewer orifices are used, each orifice has a larger individual cross-sectional area. Maintaining a consistent total orifice surface area enables control of pressure buildup within the inner chamber 124 and influences discharge characteristics when the packaged beverage is opened. In example embodiments, the total orifice surface area defined by the first orifice 125A and the second orifice 125B is in a range from 0.1mm² to 0.5mm², including ranges of 0.2mm² to 0.4mm² and 0.3mm² to 0.4mm².

In some embodiments, one or both of the first orifice 125A and the second orifice 125B include a gas-permeable membrane. The gas-permeable membrane permits passage of gas while restricting passage of liquid into the inner chamber 124. Suitable membranes include PTFE membranes and other hydrophobic, gas-permeable materials. The inclusion of a gas-permeable membrane further enhances controlled gas exchange between the packaged beverage and the inner chamber 124 while maintaining the inner chamber 124 in a gas-filled state.

The first orifice 125A and the second orifice 125B are positioned at different locations on the cartridge 101. In the illustrated embodiment, the first orifice 125A is formed through the cap 104 and the second orifice 125B is formed through the bottom wall 122 of the body 102, positioning the orifices at opposite ends of the cartridge 101 along the central axis 110. The positioning and orientation of the first orifice 125A and the second orifice 125B direct gas egressing (e.g., discharging) from the inner chamber 124 in different directions.

In embodiments where the first orifice 125A and the second orifice 125B are angularly offset about the central axis 110 (or longitudinal axis) of the cartridge 101, gas discharged from the inner chamber 124 exits the cartridge 101 along different angular directions. This angular offset creates asymmetric momentum transfer between the egressing gas and the surrounding liquid, generating a torque on the cartridge 101 that induces rotational motion within the packaged beverage. As the cartridge 101 rotates, the discharged gas interacts with the surrounding liquid to form a vortex flow pattern, increasing turbulence and promoting mixing of the released gas and any additional remediating components throughout the packaged beverage.

When the packaged beverage is opened, the pressure within the packaged beverage rapidly decreases toward atmospheric pressure while the inner chamber 124 remains at an elevated pressure corresponding to the previously sealed state. This pressure differential causes gas within the inner chamber 124 to rapidly egress through the first orifice 125A and the second orifice 125B, forming localized jets that interact with the surrounding liquid.

The interaction of the gas jets with the surrounding liquid introduces shear forces and induces vortex flow within the packaged beverage. In embodiments including angular offset of the orifices, the egressing gas also generates reactive forces that contribute to rotational motion of the cartridge 101. The combination of rotational motion and jet-induced flow produces complex fluid dynamics that enhance mixing efficiency, promote redistribution of dissolved gases, and improve uniformity of gas dispersion throughout the packaged beverage.

In other embodiments, the first orifice 125A and the second orifice 125B are positioned on opposing sides of the exterior wall 120 rather than at opposite ends of the cartridge 101. In such configurations, the orifices are oriented generally perpendicular to the central axis 110 and produce laterally directed gas jets that exit the cartridge 101 in opposing directions. The lateral discharge of gas creates asymmetric momentum transfer relative to the surrounding liquid, which generates a torque on the cartridge 101 and induces rotational motion about the central axis 110. In further embodiments, additional orifices are included, such as a third orifice positioned along the exterior wall 120 and offset from the central axis 110. The inclusion of additional orifices introduces further asymmetry in the discharge pattern and may induce combined rotational and precessional motion of the cartridge 101, thereby enhancing mixing and fluid circulation within the packaged beverage.

The opposing orifice configuration provides a controlled and distributed release of gas from the inner chamber 124. By distributing discharge across multiple locations, pressure within the inner chamber 124 is relieved in a more uniform manner, which can extend the duration of gas release and improve consistency of the mixing effect. The positioning, orientation, and geometry of the first orifice 125A and the second orifice 125B are selected to achieve desired fluid dynamic behavior, including vortex formation and agitation, and may be selected based on empirical testing or simulation for different beverage compositions and container geometries.

In the illustrated embodiment, the first side 126 of the cap 104 is substantially planar and oriented approximately orthogonal to the central axis 110 of the cartridge 101. The planar configuration provides a simple geometry that facilitates manufacturing and allows for consistent formation of the first orifice 125A through the first side 126. In other embodiments, however, the first side 126 has a domed profile that defines a domed structure extending outward from an exterior surface of the cap 104. The domed structure may include one or more top stiffeners formed as raised features extending generally parallel to the central axis 110 and circumferentially spaced about the first side 126. The domed structure distributes applied forces across the first side 126, reduces localized stress concentrations, and increases rigidity of the cap 104. This configuration improves resistance to deformation under internal pressure within the inner chamber 124 and enhances structural integrity during handling and storage.

The domed structure may include a domed surface that slopes along the central axis 110 and converges toward an apex of the cap 104. The domed geometry transfers loads radially and circumferentially, improving resistance to pressure-induced deformation relative to a planar configuration. In addition, the domed structure may increase the mass of the cap 104 relative to the body 102, which can influence orientation of the cartridge 101 within a packaged beverage and promote consistent positioning during operation.

In the illustrated embodiment, the first orifice 125A extends through the first side 126 of the cap 104. In some embodiments, the first orifice 125A is formed through a blind bore defined in the first side 126, where the blind bore includes a recessed cavity extending into the cap 104 and terminating at a bottom surface through which the first orifice 125A extends. In some embodiments, the second orifice 125B formed in the bottom wall 122 of the body 102 is also defined through a blind bore. The use of blind bores for one or both of the first orifice 125A and the second orifice 125B allows the geometry and effective length of the associated channel 160 to be controlled without increasing the overall thickness of the cap 104 or the bottom wall 122. The blind bore configuration also recesses the openings of the first orifice 125A and/or the second orifice 125B relative to adjacent exterior surfaces, thereby reducing the likelihood of obstruction when the cartridge 101 contacts a surface of the beverage container and protecting the orifices from damage during handling and assembly.

In embodiments incorporating the domed structure, the geometry of the first side 126 facilitates exposure of the first orifice 125A to the packaged beverage. The domed surface reduces the likelihood that the first orifice 125A is obstructed by contact with an interior surface of a beverage container or by localized liquid accumulation. In some configurations, the first orifice 125A is positioned between adjacent top stiffeners, such that the domed surface maintains spacing between the orifice and surrounding surfaces and promotes consistent ingress of dissolved gas into the inner chamber 124.

As shown in FIGS. 2, 3, and 8, the cap 104 further includes a cap lip 130A formed at a junction between the first side 126 and the second side 128. The cap lip 130A extends circumferentially about the cap 104 and defines a transition region configured to engage the body 102. The body 102 includes the top end 112 and the bottom end 114, and at the top end 112 the body 102 includes a body lip 130B extending circumferentially about the exterior wall 120.

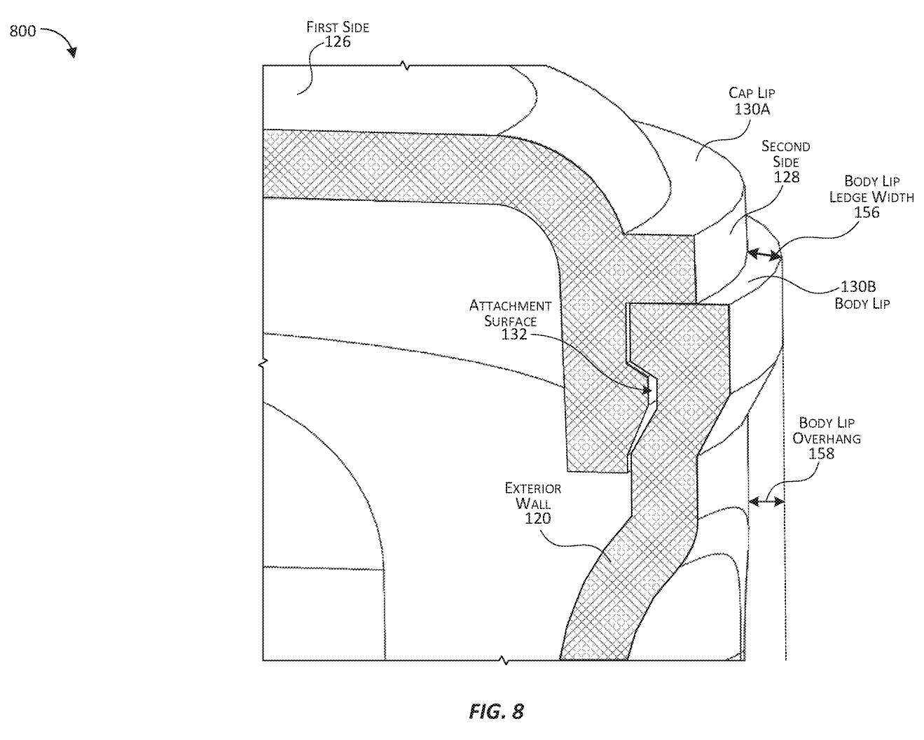

When the cap 104 is seated onto the body 102, the cap lip 130A contacts the body lip 130B to establish an interface between the cap 104 and the body 102. As detailed in FIG. 8, in some embodiments the body lip 130B extends radially outward beyond the cap lip 130A such that the body lip 130B has a greater diameter than the cap lip 130A. This configuration defines a body lip ledge width 156 corresponding to the radial offset between the cap lip 130A and the body lip 130B. In example embodiments, the body lip ledge width 156 is in a range from 0.1mm to 2.0mm, including ranges of 0.3mm to 1.5mm and 0.5mm to 1.0mm. The body lip ledge width 156 provides a defined seating surface for the cap 104, facilitates alignment during assembly, and distributes loads between the cap 104 and the body 102. The radial offset between the cap lip 130A and the body lip 130B also reduces edge sharpness at the interface, which improves durability, reduces stress concentrations, and minimizes the likelihood of chipping, deformation, or damage during handling and assembly.

In addition, the body lip 130B may extend radially outward beyond the exterior wall 120 of the body 102 to define a body lip overhang 158. The body lip overhang 158 corresponds to the radial distance by which the body lip 130B projects beyond the exterior wall 120. In example embodiments, the body lip overhang 158 is in a range from 0.1mm to 2.5mm, including ranges of 0.3mm to 2.0mm and 0.5mm to 1.5mm. The body lip overhang 158 provides a mechanical retention feature that resists separation of the cap 104 from the body 102 and increases the effective sealing interface. The overhang 158 also distributes forces generated by internal pressure within the inner chamber 124 over a larger contact region, improving sealing performance and structural reliability. Additionally, the body lip overhang 158 can shield the interface between the cap 104 and the body 102 from external contact, reducing the likelihood of unintended disengagement and protecting the sealing region during handling and transport.

As noted above, when assembled the cap 104 is securely sealed to the body 102. A secure seal between the cap 104 and the body 102 maintains structural integrity of the cartridge 101 during storage, handling, and operation within a packaged beverage. By maintaining a secure connection, the cartridge 101 retains all internal components within the inner chamber 124 and prevents separation of the cap 104 from the body 102 when subjected to internal pressure. This is particularly important for packaged beverages that are sealed under pressure, as pressure differentials occurring during opening can rapidly increase internal forces within the inner chamber 124. The secure sealing ensures that gas and any remediating components are released in a controlled manner through the first orifice 125A and the second orifice 125B, rather than through unintended gaps between the cap 104 and the body 102. In addition, maintaining the secure seal prevents portions of the cartridge 101 from interfering with the opening of the packaged beverage or becoming dislodged within the beverage, thereby improving safety and reliability of the cartridge 101. The secure sealing of the cap 104 to the body 102 may be achieved through one or more mechanisms, including an attachment surface 132 formed between the cap 104 and the body 102.

The attachment surface 132 is formed as the cap 104 is seated onto the body 102 and defines a sealing interface between the cap 104 and the body 102. In some embodiments, the attachment surface 132 comprises a pressure seal established between the cap 104 and an interior surface of the exterior wall 120 of the body 102. The pressure seal is formed by interference or compressive contact between corresponding surfaces of the cap 104 and the body 102, thereby limiting fluid communication between the inner chamber 124 and the external environment except through the first orifice 125A and the second orifice 125B.

In the illustrated embodiment, the attachment surface 132 is formed using a protrusion 136 extending from the second side 128 of the cap 104. The protrusion 136 extends radially about at least a portion of a circumference of the second side 128 and is positioned below the cap lip 130A. When the cap 104 is seated onto the body 102 such that the cap lip 130A contacts the body lip 130B, the protrusion 136 is received within the body 102 and engages the interior surface of the exterior wall 120. Contact between the protrusion 136 and the interior surface of the exterior wall 120 forms the attachment surface 132 and generates a compressive sealing force that maintains the pressure seal between the cap 104 and the body 102.

As illustrated in FIGS. 4, 5A, and 5B, the protrusion 136 defines an attachment profile configured to engage the interior surface of the exterior wall 120. In the illustrated embodiment, a reference axis 410 is shown extending generally parallel to the central axis 110 of the cartridge 101 and provides a reference for describing orientation of surfaces along the protrusion 136. The attachment surface 132 is defined by multiple adjoining surfaces, including surfaces 140, 142, 144, 146, and 148, arranged along and around the protrusion 136. These surfaces 140-148 are oriented at differing angles relative to the axis 410 and collectively define a stepped contact profile along the protrusion 136.

In the illustrated embodiment, a first angle α₁ is defined between surface 140 and adjoining surface 142, and a second angle α₂ is defined between surface 146 and adjoining surface 148. The surface 144 is disposed between the surface 142 and the surface 146 and provides an intermediate transition between the respective angled surfaces. The surfaces 140, 144, and 148 are each oriented at distinct angles relative to the axis 410, such that the adjoining surfaces define a non-uniform profile along the protrusion 136.

The first angle α₁ differs from the second angle α₂, and in the illustrated embodiment the first angle α₁ is greater than the second angle α₂. This difference in angular relationships produces a stepped contact profile configured to progressively engage the interior surface of the exterior wall 120 as the cap 104 is seated onto the body 102. In particular, the larger first angle α₁ facilitates initial engagement and insertion of the protrusion 136 into the body 102 by reducing insertion resistance at a leading portion of the protrusion 136. The smaller second angle α₂ increases contact pressure at a trailing portion of the protrusion 136, thereby enhancing interference, retention, and sealing performance once the cap 104 is fully seated. This progressive engagement distributes contact forces along the protrusion 136, reduces localized stress concentrations, and improves resistance to leakage under internal pressure within the inner chamber 124.

In example embodiments, the first angle α₁ and the second angle α₂ are defined relative to the axis 410 as illustrated in FIG. 4. In some embodiments, the first angle α₁ is measured as an obtuse angle between the surface 140 and the axis 410, such that α₁ is in a range from 150 degrees to 175 degrees (corresponding to an incidence angle of approximately 5 degrees to 30 degrees relative to the axis 410). The second angle α₂ is measured between the surface 146 and the axis 410 and may be oriented to define a more pronounced engagement feature. In some embodiments, the second angle α₂ is in a range from 60 degrees to 90 degrees relative to the axis 410. In certain configurations, the surface associated with α₂ may be oriented below a horizontal reference to define a hook-like profile that resists removal of the cap 104 once engaged with the body 102. The relative difference between the first angle α₁ and the second angle α₂ is selected to facilitate insertion of the protrusion 136 during assembly while increasing resistance to disengagement, thereby improving sealing performance and retention of the cap 104 relative to the body 102.

The differing angles between the adjoining surfaces produce a stepped contact profile that facilitates insertion of the protrusion 136 into the body 102 during assembly. As the cap 104 is advanced toward the body 102, initial contact occurs at a leading portion of the protrusion 136, and subsequent portions of the adjoining surfaces sequentially engage the interior surface of the exterior wall 120. This staged engagement reduces insertion resistance and guides the protrusion 136 into alignment with the exterior wall 120, enabling controlled seating of the cap 104 relative to the body 102.

Once the cap 104 is fully seated, the differing orientations of the adjoining surfaces collectively define a stepped contact profile that establishes distributed contact along the attachment surface 132. The sequential engagement of the adjoining surfaces increases contact area and contact force between the protrusion 136 and the interior surface of the exterior wall 120, promoting a more uniform distribution of contact forces. This distributed engagement enhances sealing performance, improves retention of the cap 104 relative to the body 102, and increases resistance to leakage from the inner chamber 124 under internal pressure.

In some embodiments, the attachment surface 132 formed between the cap 104 and the body 102 defines an interference seal. The interference seal may be a radial seal formed between opposing surfaces, such as between the protrusion 136 and the interior surface of the exterior wall 120. In other embodiments, the interference seal may be an axial or face seal formed between opposing surfaces oriented along the central axis 110. The interference between components generates a compressive sealing force that limits leakage of gas from the inner chamber 124.

FIG. 5A illustrates a cross-sectional perspective 500A of the cap 104 in an open or disassembled configuration relative to the body 102. In this view, the protrusion 136 extending from the cap 104 is exposed to clearly show the geometry of the attachment features. In particular, the adjoining surfaces 140, 142, 144, 146, and 148 are visible and arranged to form the protrusion 136. As shown, these surfaces 140-148 are oriented at differing angles relative to one another to define a stepped profile along the protrusion 136. The differing orientations of these surfaces relative to the axis 410 define the stepped contact profile that facilitates insertion of the protrusion 136 into the body 102. In particular, an initial portion of the protrusion 136, such as the surfaces 140 and 142, is configured to contact the interior surface of the exterior wall 120 during initial seating of the cap 104, after which additional surfaces sequentially engage as the cap 104 is advanced toward a fully seated position. This staged engagement reduces insertion resistance and guides the protrusion 136 into proper alignment with the exterior wall 120.

FIG. 5B illustrates a cross-sectional perspective 500B of the cartridge 101 in an assembled state, showing engagement between the cap 104 and the body 102. As shown, the protrusion 136 extending from the cap 104 is received within the body 102 and engages the interior surface of the exterior wall 120. The contact between the protrusion 136 and the interior surface of the exterior wall 120 defines the attachment surface 132, which extends along a portion of the interface between the cap 104 and the body 102. The illustrated configuration shows the protrusion 136 positioned in an interference relationship with the exterior wall 120, such that compressive forces are generated at the attachment surface 132 to establish a pressure seal.

Perspective 500B further illustrates how the adjoining surfaces 140, 142, 144, 146, and 148 are arranged along the protrusion 136 and sequentially engage the interior surface of the exterior wall 120. As shown, the stepped contact profile defined by the differing orientations of the adjoining surfaces 140-148 produces distributed contact along the attachment surface 132. This distributed engagement increases the effective sealing area and promotes uniform contact pressure between the cap 104 and the body 102. The resulting sealing interface enhances retention of the cap 104 and improves resistance to leakage from the inner chamber 124 under internal pressure.

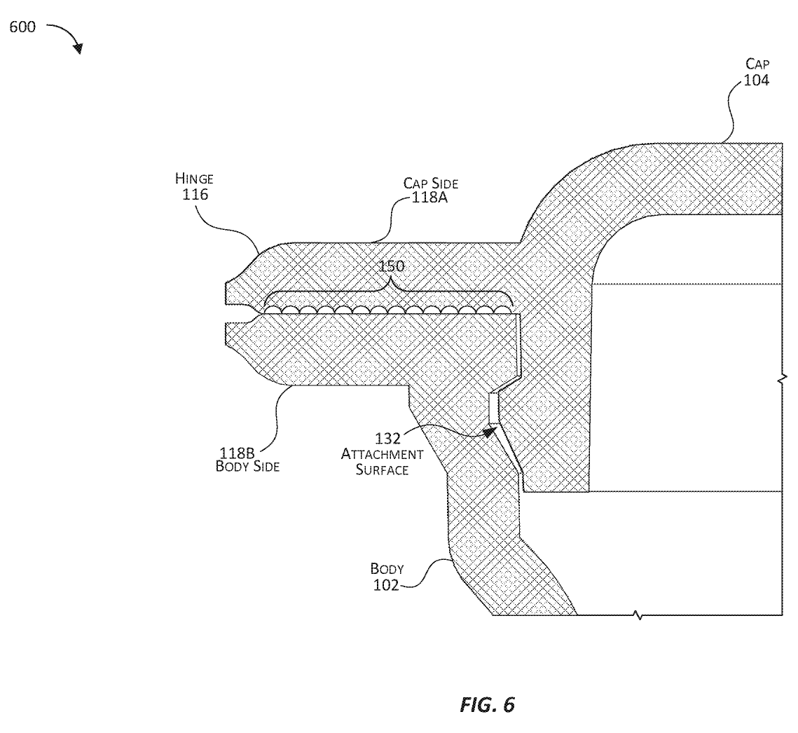

In some embodiments, additional sealing is provided at the hinge 116. As illustrated in perspective 600 of FIG. 6, a sealing surface 150 is formed between the cap side 118A and the body side 118B of the hinge 116 when the cap 104 is secured to the body 102. The sealing surface 150 is defined by one or more ribs formed along the body side 118B of the hinge 116, which extend toward the cap side 118A. When the cap 104 is moved to a closed position, the ribs contact the opposing surface of the cap side 118A to form a localized sealing interface at the hinge 116.

In some embodiments, the sealing surface 150 is formed from a compressible material or includes compressible features, such that the ribs deform when the cap 104 is secured to the body 102. This deformation generates contact pressure between the cap side 118A and the body side 118B, thereby forming a seal that limits fluid communication across the hinge 116. The sealing surface 150 supplements the attachment surface 132 by providing an additional barrier to leakage at the hinge region, which may otherwise represent a potential leakage path due to the presence of the hinge 116. This configuration improves overall sealing performance of the cartridge 101 and enhances retention of gas within the inner chamber 124 prior to opening of the packaged beverage.

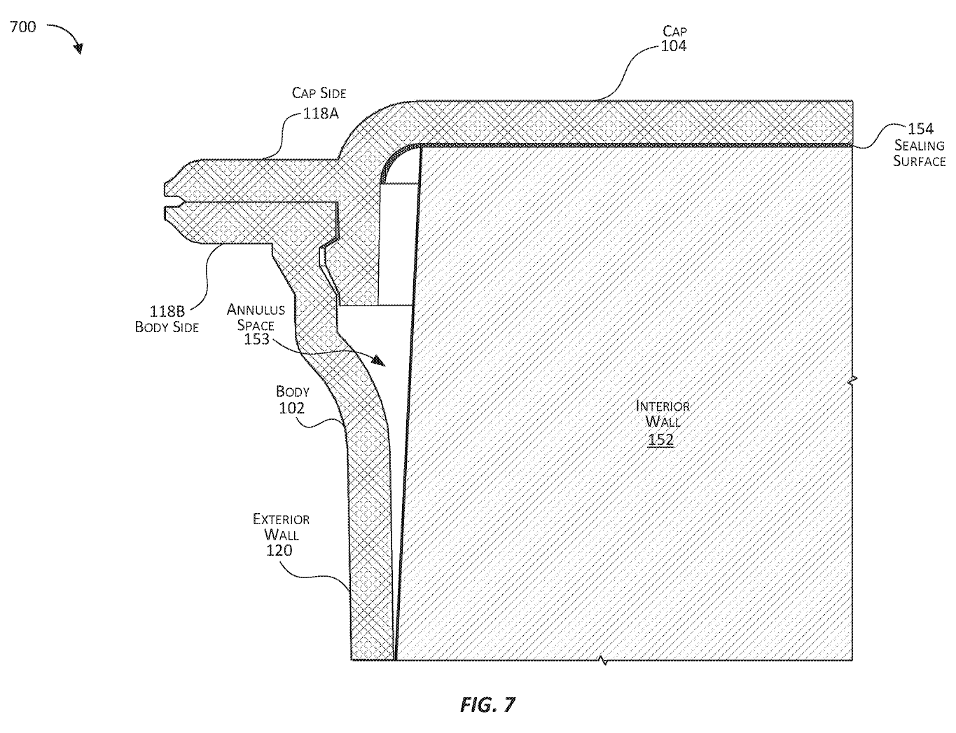

FIG. 7 illustrates a cross-sectional perspective of the cartridge 101 showing an embodiment involving additional internal sealing. In the illustrated embodiment, the body 102 includes an interior wall 152 extending from the bottom end 114 of the body 102 toward the cap 104. The interior wall 152 has a length selected such that, when the cap 104 is secured to the body 102, a top end of the interior wall 152 contacts a sealing surface 154 formed on an interior surface of the cap 104.

The sealing surface 154 is positioned on the interior surface of the cap 104 and, in some embodiments, is formed of or includes a compressible material. When the cap 104 is secured to the body 102, the top end of the interior wall 152 engages the sealing surface 154, causing the sealing surface 154 to deform and generate a compressive seal. This interface establishes a secondary sealing region within the cartridge 101 that limits fluid communication between the inner chamber 124 and surrounding regions of the cartridge 101, thereby improving containment of gas within the inner chamber 124.

As further illustrated, the interior wall 152 is spaced radially inward from the exterior wall 120 to define an annulus space 153 between the exterior wall 120 and the interior wall 152. The inner chamber 124 is defined within the interior wall 152 and is bounded by the interior wall 152, the bottom wall 122, and the cap 104 when the cap 104 is secured to the body 102. The annulus space 153 provides structural separation between the inner chamber 124 and the exterior wall 120 and may serve to isolate the inner chamber 124 from external influences, including mechanical stresses or leakage paths along the exterior wall 120.

The engagement between the interior wall 152 and the sealing surface 154 provides an additional sealing interface that supplements the attachment surface 132 and, in some embodiments, the sealing surface 150 at the hinge 116. The use of multiple sealing interfaces improves overall sealing performance of the cartridge 101, particularly under elevated internal pressures within the inner chamber 124, and reduces the likelihood of leakage during storage and operation within a packaged beverage.

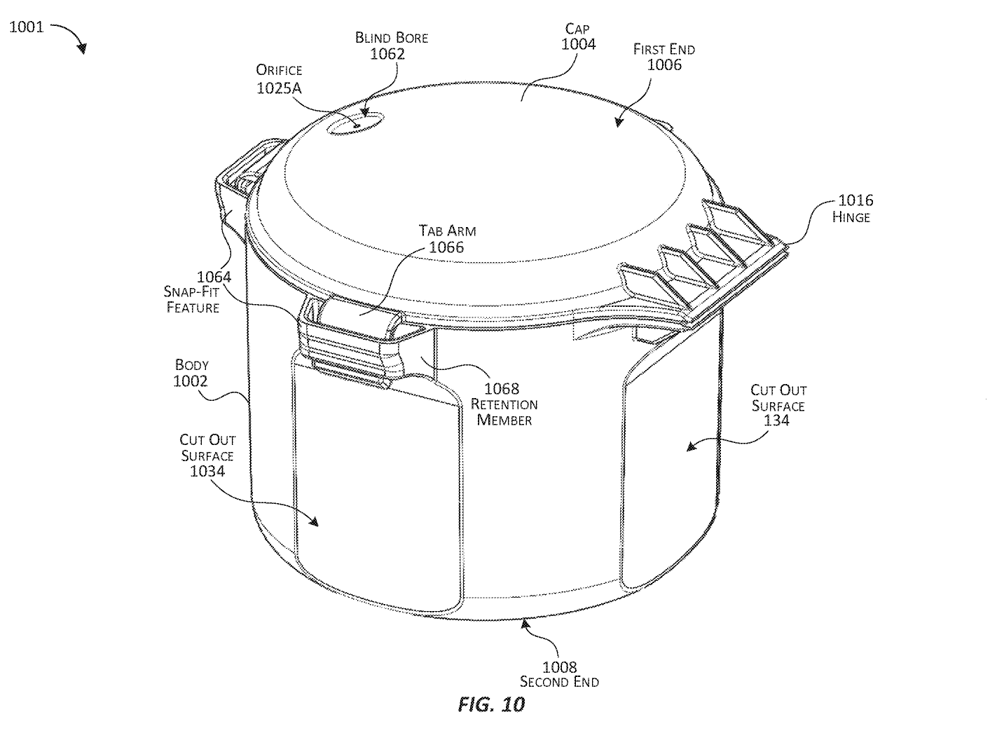

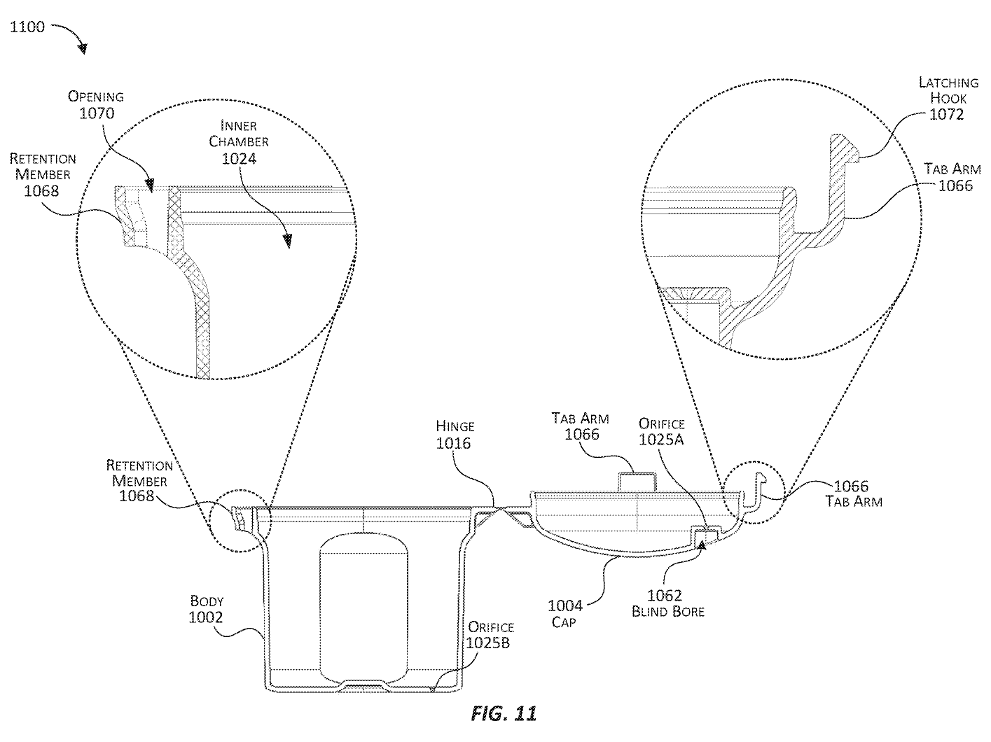

Turning now to FIGS. 10 and 11, another example cartridge 1001 is illustrated, according to embodiments herein. As shown, the cartridge 1001 is similar to the cartridge 101 described above and includes a body 1002 defining an inner chamber 1024 and a cap 1004 configured to be secured to the body 1002. The body 1002 includes an exterior wall extending between a bottom end and a top end, and the cap 1004 is configured to enclose the top end of the body 1002 to define the inner chamber 1024. The cartridge 1001 further includes one or more orifices, including a first orifice 1025A extending through the cap 1004 and a second orifice 1025B extending through the body 1002. The orifices 1025A and 1025B extend between the inner chamber 1024 and an external environment defined by a packaged beverage and permit controlled ingress and egress of gas, as described above with respect to the cartridge 101.

In this embodiment, the cap 1004 is secured to the body 1002 using one or more snap-fit features 1064. As shown, each snap-fit feature 1064 includes a retention member 1068 formed on the body 1002 and a tab arm 1066 extending from the cap 1004. The tab arm 1066 includes a latching hook 1072 at a distal end configured to engage the retention member 1068. The snap-fit features 1064 may be circumferentially spaced around the cartridge 1001, such as at evenly distributed positions about the perimeter where the cap 1004 meets the body 1002.

FIG. 11 illustrates perspective 1100, which provides enlarged views of the snap-fit features 1064 and the interaction between the tab arm 1066 and the retention member 1068. The retention member 1068 defines an opening 1070 configured to receive the latching hook 1072. During assembly, as the cap 1004 is advanced toward the body 1002, the tab arm 1066 elastically deflects as the latching hook 1072 engages an edge of the retention member 1068. Continued movement of the cap 1004 causes the latching hook 1072 to pass over the retention member 1068 until the latching hook 1072 aligns with the opening 1070. At this position, the tab arm 1066 returns toward an undeflected state and the latching hook 1072 is received within the opening 1070. Engagement between the latching hook 1072 and the retention member 1068 forms a mechanical interlock that resists separation of the cap 1004 from the body 1002.

The snap-fit features 1064 are configured to balance ease of assembly with secure retention. The tab arm 1066 is sufficiently flexible to allow repeated or controlled elastic deformation during assembly while maintaining sufficient rigidity to resist disengagement once the cap 1004 is secured. In some embodiments, the snap-fit features 1064 are positioned within an interior region of the cartridge 1001, which protects the tab arm 1066, the latching hook 1072, and the retention member 1068 from external forces and reduces the likelihood of inadvertent disengagement. This internal positioning also provides a smoother exterior profile of the cartridge 1001.

As further illustrated, the first orifice 1025A may be formed through a blind bore 1062 defined in the cap 1004. The blind bore 1062 includes a recessed cavity extending into the cap 1004 and terminating at a bottom surface through which the first orifice 1025A extends. This configuration allows the geometry and effective length of the associated channel to be controlled without increasing the overall thickness of the cap 1004. The blind bore 1062 also recesses the opening of the first orifice 1025A relative to an exterior surface of the cap 1004, thereby reducing the likelihood of obstruction when the cap 1004 contacts an interior surface of a beverage container and maintaining fluid communication between the inner chamber 1024 and the packaged beverage.

In some embodiments, the second orifice 1025B formed in the body 1002 may also be defined through a blind bore to provide similar control over flow characteristics and protection against obstruction. The use of blind bores for one or both of the orifices 1025A and 1025B enables precise control of gas ingress and egress while maintaining durability of the cartridge 1001 during handling and use.

In some embodiments, maintaining a secure seal between the cap 104/1004 and the body 102/1002 present technical difficulties due to pressure conditions within the cartridge 101/1001. When the cartridge 101/1001 is disposed within a packaged beverage, dissolved gas enters the inner chamber 124/1024 and increases internal pressure until the inner chamber 124/1024 approaches pressure equilibrium with the packaged beverage. Upon opening of the packaged beverage, rapid depressurization of the surrounding liquid results in a pressure differential that causes gas within the inner chamber 124/1024 to expand and act on the interface between the cap 104/1004 and the body 102/1002. The connection between the cap 104/1004 and the body 102/1002 is configured to withstand this pressure without separation or leakage.

In example embodiments, the pressure within the inner chamber 124/1024 may reach levels corresponding to pressures of the packaged beverage prior to opening and may further increase due to rapid expansion upon depressurization. For example, when the cartridge 101/1001 is disposed within a carbonated beverage, the pressure within the inner chamber 124/1024 may be in a range from approximately 20 pounds per square inch (PSI) to 70 PSI prior to opening, including ranges of 30 PSI to 60 PSI. Upon opening of the packaged beverage and the resulting pressure differential, localized forces acting on the cap 104/1004 may correspond to transient pressure conditions at or above 55PSI. These pressure conditions are influenced by factors including beverage type, carbonation level, temperature, and volume of the inner chamber 124/1024. The cap 104/1004 and the body 102/1002 are configured such that the attachment surface and associated sealing structures maintain engagement under these pressure conditions while permitting controlled release of gas through the orifices 125A–B/1025A–B.

In some embodiments, to accommodate these pressure conditions, the sealing and attachment structures are configured to distribute loads and maintain sealing engagement under internal pressure within the inner chamber 124/1024. In embodiments including snap-fit features, such as the cartridge 1001, multiple snap-fit features 1064 are circumferentially spaced to distribute retention forces and resist disengagement of the cap 1004 from the body 1002 under pressure-induced loading. In embodiments including the protrusion 136 and the attachment surface 132, the adjoining surfaces defining the stepped contact profile progressively engage the interior surface of the exterior wall 120 as the cap 104 is seated onto the body 102. This progressive engagement increases contact area and generates a compressive sealing force along the attachment surface 132. The differing orientations of the adjoining surfaces also create localized regions of increased interference that resist axial separation of the cap 104 from the body 102 when the inner chamber 124 is subjected to elevated pressure. In addition, engagement between the cap lip 130A and the body lip 130B provides a mechanical stop that limits relative movement between the cap 104 and the body 102. Collectively, these features enable the cartridge 101/1001 to maintain a secure seal under pressures of the type described above while permitting controlled discharge of gas through the orifices 125A–B/1025A–B.

While snap-fit features and interference-based sealing structures are illustrated, other attachment and sealing mechanisms may be used. These include threaded connections, friction fits, ultrasonic welding, adhesive bonding, or heat sealing. The selected attachment mechanism provides a secure, long-lasting connection between the cap 104 and the body 102 that maintains integrity of the cartridge throughout storage, handling, and operation within a packaged beverage.

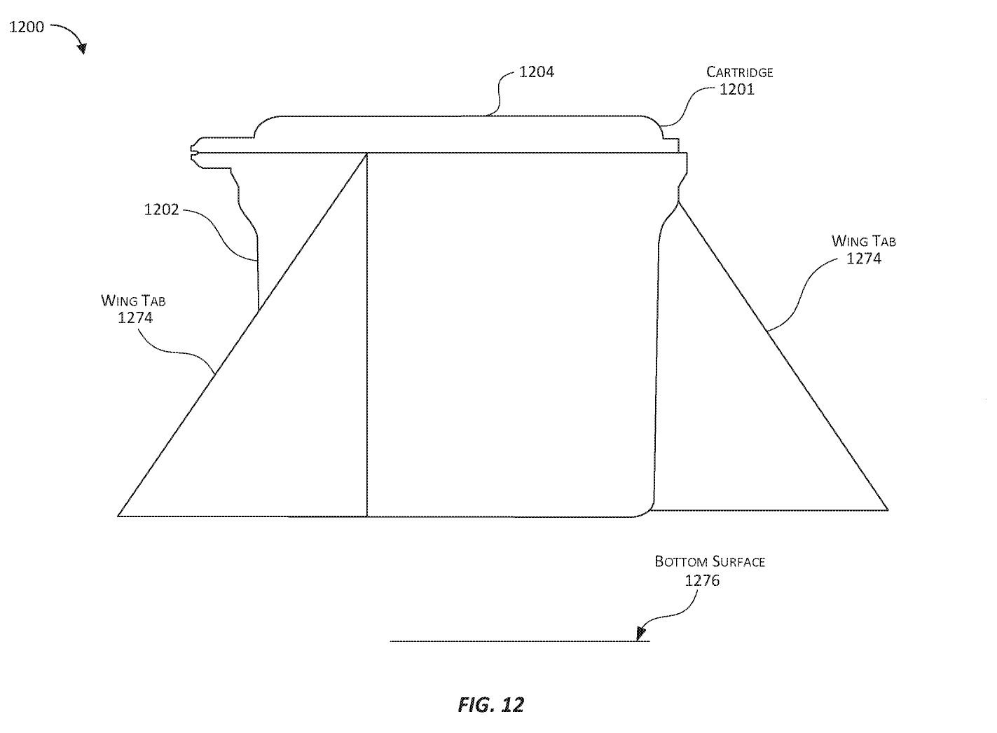

Turning now to FIG. 12, another example cartridge 1201 is illustrated, according to embodiments herein. The cartridge 1201 may be the same as or similar to the cartridge 101 and/or the cartridge 1001 described above, including a body 1202 defining an inner chamber and a cap 1204 secured to the body 1202. As such, the cartridge 1201 may include the features described above, including one or more orifices configured to permit ingress and egress of gas and, in some embodiments, one or more remediating components disposed within the inner chamber.

As shown in FIG. 12, the cartridge 1201 includes one or more wing tabs 1274 extending from the body 1202. The wing tabs 1274 are configured to engage an interior surface of a beverage container to limit movement of the cartridge 1201 within a packaged beverage. In some embodiments, the wing tabs 1274 are configured to deflect or fold toward the body 1202 during insertion of the cartridge 1201 into the packaged beverage and subsequently expand or return toward an extended configuration once positioned within the container.

When in the extended configuration, the wing tabs 1274 contact the interior surface of the beverage container and stabilize the position of the cartridge 1201. This engagement limits translational and rotational movement of the cartridge 1201 within the packaged beverage and promotes consistent positioning during operation. For example, the wing tabs 1274 may maintain the cartridge 1201 in a desired orientation relative to a bottom surface 1276 of the container, which can improve consistency of gas discharge and mixing behavior.

The wing tabs 1274 also function to prevent the cartridge 1201 from migrating within the packaged beverage during handling or consumption. In particular, the wing tabs 1274 inhibit movement of the cartridge 1201 toward an opening of the container when the packaged beverage is tilted or inverted, thereby reducing the likelihood that the cartridge 1201 obstructs the opening or exits the container during use. This improves both safety and user experience.

In some embodiments, the wing tabs 1274 are formed as solid structures extending from the body 1202. In other embodiments, the wing tabs 1274 may include openings or a skeletal framework to reduce material usage and minimize interference with fluid flow within the packaged beverage while maintaining sufficient structural engagement with the container. The wing tabs 1274 may be formed integrally with the body 1202 or may be formed from a different material selected to enhance flexibility, resilience, or deployment characteristics.

In addition to limiting movement of the cartridge 1201 within the packaged beverage, stabilization of the cartridge 1201 via the wing tabs 1274 enhances performance of the orifices, such as the orifices 125A-B, during discharge. As described above, gas egressing from the inner chamber through the orifices may be directed in opposing or angularly offset directions to generate vortex flow within the packaged beverage. Maintaining the cartridge 1201 in a substantially fixed position during discharge allows the direction and momentum of the egressing gas streams to be preserved, thereby promoting formation of a consistent and well-defined vortex. In contrast, uncontrolled movement or rotation of the cartridge 1201 can dissipate the directed flow of gas and reduce mixing efficiency. By maintaining positional stability, the wing tabs 1274 improve the interaction between the discharged gas and the surrounding liquid, resulting in enhanced mixing, agitation, and distribution of gas and any remediating components within the packaged beverage.

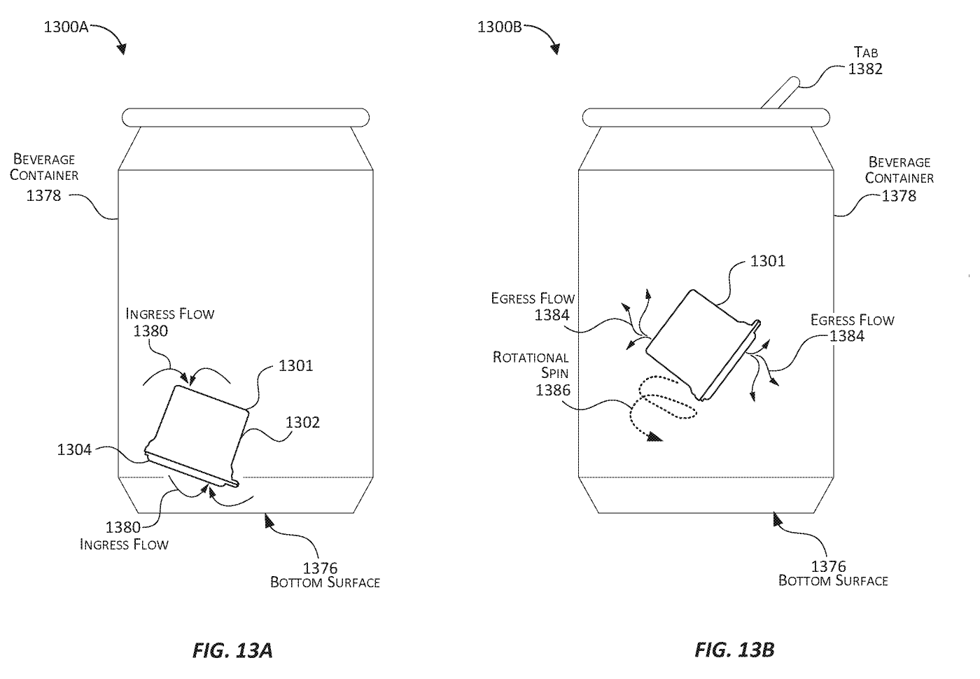

However, in some embodiments, it may be desirable to induce rotational motion of the cartridge during discharge to further enhance mixing within the packaged beverage. Referring now to FIGS. 13A and 13B, perspectives 1300A and 1300B illustrate operation of a cartridge 1301 within a beverage container 1378, according to embodiments herein. The cartridge 1301 may be the same as or similar to the cartridge 101, 1001, or 1201 described above, including a body and a cap defining an inner chamber and one or more orifices configured to permit ingress and egress of gas.

As illustrated in FIG. 13A, when the cartridge 1301 is disposed within the beverage container 1378, dissolved gas from the packaged beverage flows into the inner chamber through one or more orifices, as indicated by ingress flow 1380. The cartridge 1301 may settle within the beverage container 1378, such as along a bottom surface 1376, where the orientation of the cartridge 1301 may be influenced by the geometry and mass distribution of the cartridge, including features of the cap and body.

Referring to FIG. 13B, upon opening of the beverage container 1378, such as via tab 1382, the pressure differential between the inner chamber and the surrounding packaged beverage causes gas to egress from the cartridge 1301 through the orifices, as indicated by egress flow 1384. In some embodiments, the orifices are positioned on opposing sides of the cartridge 1301 and are oriented such that gas is discharged in opposing directions. This opposing discharge generates reactive forces acting on the cartridge 1301, which induce rotational motion of the cartridge 1301 within the packaged beverage, as indicated by rotational spin 1386. For example, the opposing discharge produces a net torque about the central or longitudinal axis of the cartridge 1301 that induces rotational spin 1386 of the cartridge 1301.

The rotational motion of the cartridge 1301, in combination with the opposing egress flows 1384, enhances mixing and agitation within the packaged beverage. The rotation increases interaction between the discharged gas and the surrounding liquid, promoting formation of complex flow patterns and improving distribution of gas and any remediating components throughout the beverage. In some embodiments, the cartridge 1301 further includes one or more external structures, such as ribs, fins, or baffles formed on an exterior surface of the body. These external structures interact with the surrounding liquid as the cartridge 1301 rotates, generating additional turbulence and disrupting boundary layers adjacent to the cartridge surface. This increased turbulence further enhances mixing efficiency and promotes more uniform dispersion of gas and remediating components within the packaged beverage.

In some embodiments, the cartridge 1301 may be designed to settle at or near the bottom surface 1376 of the beverage container. Such positioning the cartridge 1301 near the bottom surface 1376 of the beverage container allows discharged gas and remediating components to interact with the bottom surface 1376 and disperse upward through the liquid. This upward dispersion increases residence time of the released components within the beverage prior to consumption, thereby improving mixing efficiency and reducing the likelihood that a consumer experiences localized concentrations of released components.

The foregoing examples and descriptions are described herein in the context of systems and methods for providing a cartridge for enhancing packaged beverages upon consumption. Those of ordinary skill in the art will realize that these descriptions are illustrative only and are not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer’s specific goals, such as compliance with application- and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in an embodiment,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number respectively. The word "or," in reference to a list of two or more items, covers all the following interpretations of the word: any of the items in the list, all the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for” but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a cartridge for enhancing a packaged beverage, the cartridge comprising: a cylindrical body having a top end and a bottom end, the cylindrical body comprising an exterior wall extending from the bottom end towards the top end to form an inner chamber comprising an opening at the top end, and a bottom wall forming a bottom surface of the inner chamber, wherein the bottom wall comprises a first orifice defining a first channel extending between the inner chamber and an exterior environment; and a cap configured to secure to the top end of the cylindrical body, wherein the cap comprises a first side and a second side, wherein the second side is approximately perpendicular to the first side, each of the first side and the second side comprising an interior surface opposing an exterior surface, wherein the second side comprises an attachment surface forming a seal between the cap and the exterior wall of the cylindrical body, and wherein the cap further comprises a second orifice defining a second channel extending between the interior surface and the exterior surface of the first side.

Example 2 is the cartridge of any preceding or following example, wherein the first orifice and the second orifice are offset from one another and oriented to direct gas to egress from the inner chamber in opposing directions.

Example 3 is the cartridge of any preceding or following example, wherein the second channel tapers from a first diameter at the inner chamber to a second diameter at the exterior environment, wherein the taper forms an angle of at least 10 degrees relative to a longitudinal axis of the second channel.

Example 4 is the cartridge of any preceding or following example, further comprising a living hinge attached on a first end to the cap and on a second end to the cylindrical body, wherein the living hinge comprises a hinge web defined by a localized reduced-thickness section.

Example 5 is the cartridge of any preceding or following example, wherein the first orifice and the second orifice comprise restricted cross-sectional areas forming corresponding channels between the inner chamber and the exterior environment, wherein the restricted cross-sectional areas are dimensioned to permit ingress of gas dissolved in the packaged beverage into the inner chamber until pressure equilibrium is achieved, and to restrict outflow of the gas until the packaged beverage is opened such that gas egress generates a vortex within the packaged beverage.

Example 6 is the cartridge of any preceding or following example, wherein the attachment surface comprises a protrusion extending circumferentially about the second side of the cap, the protrusion configured to contact an interior surface of the exterior wall of the cylindrical body to form a compression seal.

Example 7 is the cartridge of any preceding or following example, wherein the protrusion comprises a plurality of adjoining surfaces including a first surface, a second surface adjoining the first surface, and additional adjoining surfaces, wherein a first angle between the first and second surfaces differs from a second angle between other adjoining surfaces.

Example 8 is the cartridge of any preceding or following example, wherein the exterior wall comprises one or more cutouts forming one or more flat surfaces on the cylindrical body.

Example 9 is a cartridge for use with a beverage container, the cartridge comprising: a cylindrical body having an exterior wall defining an inner chamber and a body lip at an open end; and a cap configured to be secured to the cylindrical body, the cap including a side wall and a protrusion extending from the side wall, and a second orifice extending between the inner chamber and an exterior environment, wherein the protrusion comprises a plurality of adjoining surfaces arranged at differing orientations relative to a longitudinal axis of the cylindrical body to define a stepped contact profile configured to progressively engage the cylindrical body to form an attachment surface.

Example 10 is the cartridge of any preceding or following example, wherein the plurality of adjoining surfaces comprises at least five adjoining surfaces, and wherein adjoining surfaces define differing angles relative to one another.

Example 11 is the cartridge of any preceding or following example, wherein the stepped contact profile is configured to produce radial compression between the protrusion and an interior surface of the cylindrical body to form a sealing attachment interface.

Example 12 is the cartridge of any preceding or following example, wherein the cap comprises a blind bore having a flat bottom surface through which the second channel extends.

Example 13 is the cartridge of any preceding or following example, wherein the first channel and the second channel each taper from a first diameter at the inner chamber to a second diameter at the exterior environment, and wherein the taper forms an angle of at least 10 degrees relative to a central axis of the respective channel.

Example 14 is the cartridge of any preceding or following example, wherein the first orifice and the second orifice are angularly offset about a longitudinal axis of the cylindrical body.

Example 15 is the cartridge of any preceding or following example, wherein the cap is secured to the cylindrical body by one or more snap-fit features, each snap-fit feature comprising a tab arm having a latching hook configured to engage a retention member on the cylindrical body.

Example 16 is a packaged beverage comprising: a container containing a beverage; and a cartridge disposed within the container, the cartridge including a cylindrical body and a cap secured to the cylindrical body, wherein the cylindrical body defines an inner chamber and includes a first orifice, and the cap includes a second orifice, wherein the first orifice and the second orifice are configured to permit dissolved gas from the beverage to ingress into the inner chamber until pressure equilibrium is established, and to discharge the gas upon depressurization of the container to generate vortex flow within the beverage.

Example 17 is the packaged beverage of any preceding or following example, wherein the first orifice and the second orifice are angularly offset such that discharged gas produces rotational motion of the cartridge within the beverage.

Example 18 is the packaged beverage of any preceding or following example, wherein the cartridge comprises a unitary body forming the cylindrical body and the cap.

Example 19 is the packaged beverage of any preceding or following example, wherein the cap is secured to the cylindrical body to maintain sealing engagement at an internal pressure of at least 55psi.

Example 20 is the packaged beverage of any preceding or following example, wherein the cartridge comprises a plurality of wing tabs configured to contact an interior surface of the container to limit movement of the cartridge.

What is claimed:

1. A cartridge for enhancing a packaged beverage, the cartridge comprising:
a cylindrical body having a top end and a bottom end, the cylindrical body comprising:
an exterior wall extending from the bottom end towards the top end to form an inner chamber comprising an opening at the top end; and
a bottom wall forming a bottom surface of the inner chamber, wherein the bottom end comprises the bottom wall, wherein the bottom wall comprises a first orifice defining a first channel extending between the inner chamber and an exterior environment; and
a cap configured to secure to the top end of the cylindrical body, wherein the cap comprises:
a first side and a second side, wherein the second side is approximately perpendicular to the first side, each of the first side and the second side comprising an interior surface opposing an exterior surface, wherein:
the second side comprises an attachment surface; and
the attachment surface forms a seal between the cap and the exterior wall of the cylindrical body; and
a second orifice defining a second channel extending between the interior surface and the exterior surface of the first side of the cap.

2. The cartridge of claim 1, wherein the first orifice and the second orifice are offset from one another and oriented to direct gas to egress from the inner chamber in opposing directions.

3. The cartridge of claim 1, wherein the second channel of the second orifice tapers from a first diameter at the inner chamber to a second diameter at the exterior environment, wherein the taper forms an angle of at least 10 degrees relative to a longitudinal axis of the second channel.

4. The cartridge of claim 1, wherein the cartridge further comprises a living hinge attached on a first end to the cap and on a second end to the cylindrical body, wherein the living hinge comprises a hinge web defined by a localized reduced-thickness section between the first end and the second end.

5. The cartridge of claim 1, wherein the first orifice and the second orifice comprise a restricted cross-sectional area forming a corresponding channel between the inner chamber and the environment exterior to the cartridge, wherein the restricted cross-sectional area of the respective orifice is dimensioned to:
permit ingress of gas dissolved in the packaged beverage into the inner chamber until a pressure equilibrium is achieved between the inner chamber and the packaged beverage; and
restrict outflow of the gas from the inner chamber until the packaged beverage is opened such that volumetric expansion of the gas within the inner chamber causes the gas to egress through the respective orifice in a manner that creates a vortex within the packaged beverage, the vortex being generated by the pressure differential between the inner chamber and the depressurized packaged beverage upon opening.

6. The cartridge of claim 1, wherein the attachment surface comprises a protrusion extending circumferentially about the second side of the cap, the protrusion configured to contact an inner surface of the exterior wall of the cylindrical body to form a compression seal between the cap and the exterior wall of the cylindrical body.

7. The cartridge of claim 6, wherein the protrusion comprises a plurality of adjoining surfaces including a first surface, a second surface adjoining the first surface, and a third surface disposed between the second surface and a fourth surface adjoining a fifth surface, wherein the second surface forms a first angle with the first surface and the fourth surface forms a second angle with the fifth surface, the first angle differing from the second angle.

8. The cartridge of claim 1, wherein the exterior wall comprises one or more cutouts forming one or more flat surfaces on the cylindrical body.

9. A cartridge for use with a beverage container, the cartridge comprising:
a cylindrical body having an exterior wall defining an inner chamber and a body lip at an open end of the cylindrical body, the cylindrical body including a first orifice extending between the inner chamber and an exterior environment; and
a cap configured to be secured to the cylindrical body, the cap including a side wall and a protrusion extending from the side wall, the cap further including a second orifice extending between the inner chamber and the exterior environment,
wherein the protrusion comprises a plurality of adjoining surfaces arranged at differing orientations relative to a longitudinal axis of the cylindrical body, the plurality of adjoining surfaces defining a stepped contact profile configured to progressively engage the cylindrical body as the cap is seated onto the cylindrical body to form an attachment surface.

10. The cartridge of claim 9, wherein the plurality of adjoining surfaces comprises a first surface, a second surface adjoining the first surface, a third surface adjoining the second surface, a fourth surface adjoining the third surface, and a fifth surface adjoining the fourth surface, wherein the second surface forms a first angle with the first surface and the fourth surface forms a second angle with the fifth surface, the first angle differing from the second angle.

11. The cartridge of claim 9, wherein the stepped contact profile is configured to produce radial compression between the protrusion and an interior surface of the cylindrical body as the cap is seated onto the cylindrical body to form a sealing attachment interface.

12. The cartridge of claim 9, wherein the cap comprises a blind bore having a flat bottom surface through which the second channel of the second orifice extends between the inner chamber and the exterior environment.

13. The cartridge of claim 9, wherein:
the first orifice comprises a first restricted cross-sectional area forming a first channel between the inner chamber and the exterior environment;
the second orifice comprises a second restricted cross-sectional area forming a second channel between the inner chamber and the exterior environment;
each of the first channel of the first orifice and the second channel of the second orifice taper from a first diameter at the inner chamber to a second diameter at the exterior environment; and
the taper forms an angle of at least 10 degrees relative to a central axis of the first channel and the second channel respectively.

14. The cartridge of claim 9, wherein the first orifice and the second orifice are angularly offset about a longitudinal axis of the cylindrical body.

15. The cartridge of claim 9, wherein the cap is secured to the cylindrical body by one or more snap-fit features, each of the one or more snap-fit features comprising:
a tab arm extending from the first side of the cap, the tab arm having a latching hook at a distal end; and
a retention member disposed on the exterior wall of the cylindrical body,
wherein the latching hook is configured to engage the retention member to secure the cap to the cylindrical body.

16. A packaged beverage comprising:
a container containing a beverage; and
a cartridge disposed within the container, the cartridge including a cylindrical body and a cap secured to a top end of the cylindrical body, wherein:
the cylindrical body defines an inner chamber and comprises a first orifice extending between the inner chamber and beverage; and
the cap comprises a second orifice extending between the inner chamber and the beverage, wherein:
the first orifice and the second orifice are configured to permit dissolved gas from the beverage to ingress into the inner chamber until pressure equilibrium is established between the inner chamber and the beverage;
the first orifice and the second orifice are oriented to discharge ingressed gas from the inner chamber in opposing directions; and
the first orifice and the second orifice each define a restricted cross-sectional channel between the inner chamber and the beverage such that, upon depressurization of the container, the ingressed gas is discharged through the first orifice and the second orifice into the beverage to generate vortex flow within the beverage.

17. The packaged beverage of claim 16, wherein the first orifice and the second orifice are angularly offset on opposing sides of the cartridge such that the ingressed gas discharged from the inner chamber produces rotational motion of the cartridge within the beverage.

18. The packaged beverage of claim 16, wherein the cartridge comprises a unitary body forming the cylindrical body and the cap.

19. The packaged beverage of claim 16, wherein the cap is secured to the cylindrical body so as to maintain sealing engagement at an internal pressure within the inner chamber of at least 55psi.

20. The packaged beverage of claim 16, wherein the cartridge comprises a plurality of wing tabs configured to contact an interior surface of the container to limit movement of the cartridge within the container.
